(19) United States
(12) Patent Application Publication
(10) Pub. No.: US 2017/0226362 A1
(43) Pub. Date: Aug. 10, 2017

(54) REFRACTORY METAL INKS AND RELATED SYSTEMS FOR AND METHODS OF MAKING HIGH-MELTING-POINT ARTICLES

(71) Applicant: QI2 Elements, LLC, Kent, WA (US)

(72) Inventors: Vincent Fratello, Bellevue, WA (US); Giovanni Nino, Issaquah, WA (US); Arjun Wadhwa, Kent, WA (US)

(73) Assignee: QI2 Elements, LLC, Kent, WA (US)

(21) Appl. No.: 15/429,080

(22) Filed: Feb. 9, 2017

Related U.S. Application Data
(60) Provisional application No. 62/293,092, filed on Feb. 9, 2016.
(60) Provisional application No. 62/296,997, filed on Feb. 18, 2016.

(51) Int. Cl. C09D 11/52; C04B 41/00; B41F 15/34; H01B 1/02; B41J 2/215; C09D 11/033; C04B 41/51

(52) U.S. Cl. CPC C09D 11/52; C09D 11/033; C04B 41/009; C04B 41/5122; C04B 41/5133; C04B 41/5144; C04B 41/5116; H01B 1/02; B41J 2/215; B41F 15/34; B41P 2215/12; G01B 21/32

(57) ABSTRACT

Thin films of precious metals such as platinum and gold have the required ability to withstand high temperatures, but in pure form can suffer from grain growth, agglomeration and dewetting at high temperature. Grain boundaries must therefore be pinned by alloying with other metals and/or by inclusion of non-metallic nanoparticles. While such bulk materials are known in the prior art, they have not existed previously as printable inks that can be deposited by additive manufacturing direct-write methods. These materials have been formulated for the first time as alloy and composite inks so that they may be applied by direct-write additive manufacturing techniques directly onto three-dimensional components or on high temperature substrates that can be adhered to complex components.

### CROSS-REFERENCES TO RELATED APPLICATIONS

This application claims the benefit of U.S. Provisional Patent Application No. 62/293,092, filed Feb. 9, 2016, and U.S. Provisional Patent Application No. 62/296,997, filed Feb. 18, 2016, the disclosures of which are incorporated herein by reference in their entirety.

### STATEMENT OF GOVERNMENT LICENSE RIGHTS

This invention was made with Government support under contract NNX16CL40P awarded by NASA. The Government has certain rights in the invention.

### BACKGROUND

Conducting materials are the backbone of most sensors and a wide variety of electrical and electronic devices. Their use for high temperature applications requires that they be stable not just against melting, but also against property changes when used at high temperature over an extended period. There are a wide variety of refractory (high melting point) metals that have high melting temperature, but in their elemental form they are subject to physical changes that can impact their functional properties.

Grain Structure Changes

Most metals crystallize when they solidify so that the atoms are ordered in a specific three-dimensional pattern called the crystal structure. In the absence of external factors (e.g. strain) or ordering (e.g. ferroelectricity) the lowest energy configuration is to form a single crystal since the boundary between two crystals of different orientation (called a grain boundary) creates excess free energy. In practice this seldom occurs because of a combination of thermodynamics, kinetics and thermo-mechanical history of the article so there is also a “grain structure.” These grain boundaries impede the motion of dislocations and also affect the flow of electrons. Single element metal articles, especially noble metals such as platinum (Pt), palladium (Pd), gold (Au) and silver (Ag) have high atomic mobilities at high temperatures so that they can recrystallize, agglomerate, and generally change their grain structure in ways that change the mechanical and electrical properties being used or tested. This requires that the grain boundaries in the crystal move through rearrangement of the atoms at the interface between grains so that atoms move from the orientation of one grain to the other. This occurs most easily if there is only one type of atom.

Oxidation

Other refractory metals such as chromium (Cr), molybdenum (Mo), tungsten (W), nickel (Ni), rhodium (Rh), and iridium (Ir) are prone to form oxides at high temperature in an air atmosphere and so may change their composition and thus their resistance.

High temperature conducting articles require refractory metals that are stable against melting, oxidation, and corrosion, most commonly satisfied by noble metals and certain refractory alloys. Table I gives a list of the significant noble metals and other refractory metal elements to be discussed herein and some applicable properties.

The last column of Table I shows that precious metals such as Au, Ag, and Pt have oxides with a positive free energy of formation (i.e., negative oxygen affinity pO=log P_{O2} where P_{O2} is the equilibrium oxygen concentration for oxide formation at 1000K). Formation of such oxides is not thermodynamically favored in air. On the other hand, Ir, Rh, Re, Ni, Mo, Fe, W, and Cr have positive pO (see Table I). These oxides more readily form in an oxygen concentration defined by pO, also depending on the temperature. Pd nominally has a positive pO, but experience shows it will oxidize unless the atmosphere is at least neutral.

TABLE I
Crystal Structure, Bulk Lattice Parameter (LP), Ionic Radius
(IR), Melting Temperature (Tm), Vickers Hardness of a 5%
alloy in Pt (V) and Oxygen Affinity (pO) of Some Noble/Refractory
Metals Ordered According to Oxygen Affinity.

| Element | Structure | LP(Å) | IR(Å) | Tm(° C.) | V [1] | pO [2] |
|---|---|---|---|---|---|---|
| Au | FCC | 4.079 | 1.74 | 1064 | 98 | −5.5 |
| Ag | FCC | 4.085 | 1.65 | 961 | 81 | −3.3 |
| Pt | FCC | 3.924 | 1.77 | 1768 | | −1.3 |
| Pd | FCC | 3.891 | 1.69 | 1555 | 50 | −1.1 |
| Ir | FCC | 3.839 | 1.80 | 2719 | 93 | 0.7 |
| Rh | FCC | 3.803 | 1.73 | 2237 | 55 | 0.9 |
| Re | Hex | | 1.88 | 3458 | | 13.6 |
| Ni | FCC | 3.524 | 1.49 | 1728 | 126 | 16.2 |
| Mo | BCC | 3.147 | 1.90 | 2896 | | 20.1 |
| Fe | BCC | 2.866 | 1.56 | 1811 | | 20.6 |
| W | BCC | 3.165 | 1.93 | 3695 | 151 | 21.2 |
| Cr | BCC | 2.910 | 1.66 | 2180 | | 30.1 |

[1] T. Biggs, S. S. Taylor and E. van der Lingen, “The Hardening of Platinum Alloys for Potential Jewellery Application,” Platinum Metals Rev. 49 (2005) 2.
[2] T. B. Reed, Free Energy of Formation of Binary Compounds, The Massachusetts Institute of Technology, Cambridge, Mass. (1971) p. 67.

High Temperature Stable Alloys

Metal alloys have different properties from elements because the two different types of atoms can have different behaviors. A substance that is a mixture of two or more elements may have different forms depending on its composition:

The mixture can be a compound of two or more elements that has a strong thermodynamic preference for an ordered structure of specific ratios among the atoms. There are compounds that occur between platinum and tungsten as will be discussed further in this description.

The mixture can phase separate into two different phases of differing compositions. The simplest case of this is two materials that have almost no solubility of one with another. An example of this that will be discussed later in this description is platinum with zirconium oxide inclusions.

The mixture can be a “solid solution” wherein one element dissolves in another and substitutes for it on some of the atomic sites. The gold-silver phase diagram of FIG. 21 is an example of a complete solid solution.

The free energy of a reaction, ΔG, of a material at constant pressure is typically given in a simplified form

ΔG=ΔH−TΔS (1)

where ΔH is the enthalpy change, T is the temperature and ΔS is the entropy change. This assumes there are no other significant sources of free energy such as magnetic, electrical, stress, etc. The difference in free energy between two phase separated elements and two elements in solid solution is given by the enthalpy and entropy of mixing. For an ideal solid solution, the entropy of mixing is given by

ΔS_{M}=−R[X ln X+(1−X)ln(1−X)] (2)

where R is the ideal gas constant X is the mole fraction of solute A in solvent B and the natural logarithm function is signified by ln. An equally idealized first order equation for the enthalpy of mixing is

ΔH_{M}=zX(1−X)[H_{AB}−(H_{AA}+H_{BB})/2] (3)

where z is the number of nearest neighbor coordination bonds in the A structure, H_{AB} is the enthalpy of a bond between A and B atoms, H_{AA} is the enthalpy of a bond between two A atoms and H_{BB} is the enthalpy of a bond between two B atoms. If this enthalpy is negative, then mixing is energetically favorable, often resulting in compound formation if the ratios are right. If this enthalpy is positive, then it will tend to counteract the entropy of mixing, more strongly in the center of the phase diagram where X(1−X) achieves its maximum value. Depending on the relative strengths of the enthalpy and entropy terms, this competition can result in clustering of B atoms or partial to complete phase separation. FIG. 1 shows spinodal decomposition where phase separation occurs for a wider and wider composition range as the temperature decreases.

Either clustering (segregation) or phase separation can impact the grain boundary because atomic disorder is most favored thermodynamically at this transition region where it can relieve some of the stress. Such structuring pins the grain boundary in place because grain boundary motion no longer is a simple matter of rearranging single atoms, but involves dragging all the segregated/phase separated atoms along with the grain boundary. This effect then “hardens” the alloy both against thermal recrystallization and physical deformation.

Because of platinum's high melting temperature and resistance to oxidation/corrosion, alloys with platinum are most likely to be robust and stable to high temperatures ˜1000° C. Table I suggests how various noble and refractory metals might be compatible alloying into platinum. As discussed above, the formation of solid solutions depends substantially on the enthalpy of mixing through the difference in enthalpies between similar and mixed bonds. Elements of similar crystal structure, lattice parameter, ionic radii, melting temperature, and oxygen affinity will have a tendency for lower enthalpies of mixed bonds. The lattice parameters of the various face-centered cubic (FCC) metals do not necessarily depend exclusively on the ionic radii, though the body-centered cubic (BCC) metals listed here have more regular behavior.

Notable improved strength platinum alloys in the prior art available as wires or other bulk forms include the following.
Pt95%:Au5% is a well-known wire and crucible material hardened against deformation and grain growth. FIGS. 1 and 2 depict the behavior of the melting point, structure and lattice parameter of Pt—Au alloys.
Pt90%:Rh10%, Pt87%:Rh13%, Pt94%:Rh6%, Pt70%:Rh30% and alloys with other proportions are well known thermocouple materials and quite robust. However Rh alloying does not show as high an improvement in the Vickers hardness as other materials shown here (FIG. 3). Certainly, once fully alloyed, Pt—Rh wires are stable as shown by their use in thermocouples in air at high temperatures. This implies the heat of mixing significantly stabilizes the alloy against demixing and oxidation for this low pO, good solid solution alloying constituent.
Pt92%:W8% is a known high temperature strain gage material. FIGS. 4 and 5 depict the behavior of the melting point, structure and lattice parameter of Pt—W alloys.
Pt90%:Ni10% is a known high temperature lead wire material.

Pt90%:Ni10% and Pt92%:W8% are at more risk of forming oxide precipitates because of the higher pO of the alloying element and poorer solid solution, but such oxide precipitates may be equally or more useful in pinning grain boundaries compared to alloying.

The difference in hardness effects in FIG. 3 can be correlated with the solid solution properties. Pd and Rh have properties quite similar to Pt and form good solid solutions with spinodals at low T values of 770 and 760° C., respectively. Thus, there is less grain boundary segregation and they are less effective in improving the hardness of platinum. Ni and W have different crystal structures and properties than platinum that are less favorable to solid solution formation (though they do form compounds) and are the most effective in improving hardness.

High temperature heating element alloys are made to survive high temperatures and corrosive environments. They are accordingly hardened through alloy composition and heat treating to prevent deformation. They also self-passivate by developing an oxide coating on the surface during first heating. The impact of this coating on strain gage operation at high temperature is small, but not fully characterized. Commercially available materials include:
Nichrome wires are varying alloys of nickel and chromium with other elements and can operate to 871° C. Nichrome develops a chromium oxide coating on the surface that protects the interior of the wire from further oxidation.
Iron-chromium-aluminum alloys, e.g. Fe₇₅Cr₂₅Al₅, marketed under various trade names are rated to 816° C. for strain gages, though they operate to 1200° C. in heating elements. This material develops an aluminum oxide coating upon initial heating.

Particulate Hardening

Hardening of metals and alloys through grain boundary pinning with particulates is also well known to those knowledgeable in the art. Yttria and zirconia particles have been used to harden precious metal crucible materials and wires. PtRh and zirconia have been co-sputtered to make electrodes. (D. J. Frankel, G. P. Bernhardt, B. T. Sturtevant, T. Moonlight, M. Pereira da Cunha and R. J. Lad, “Stable Electrodes and Ultrathin Passivation Coatings for High Temperature Sensors in Harsh Environments,” Proceedings of the IEEE Sensors 2008 conference, p. 82.) Such inclusions prevent grain boundary motion by requiring that the grain boundary either move the inclusion with it or move around it. The critical characteristics are that the inclusion material is neither soluble in the metal matrix nor reactive at high temperature.

Revolutionary hard diamond-like coatings are made by chemical vapor deposition on tools, turbine blades, etc. Now such materials are being made and are commercially available as hydrogen-terminated nanodiamonds called diamondoids. Recent research on diamondoid additives in cryomilled bulk alloys suggests they can be used in small quantities ˜1% to fill voids and pin grain boundary motion in metal nanoparticle articles. (W. Chang, M. Pozuelo, J. M. Yang, “Thermally Stable Nanostructured Magnesium Nanocomposites Reinforced by Diamantane,” JOM The Journal of The Minerals, Metals & Materials Society 67 (2015) 2828.) These diamondoids can be made from natural gas condensates, but are relatively expensive compared to conventional ceramic materials. They have also been admixed in SU-8 photoresists. (H. C. Chiamori, J. W. Brown, E. V. Adhiprakasha, E. T. Hantsoo, J. B. Straalsund, N. A. Melosh, B. L. Pruitt “Suspension of Nanoparticles in SU-8 and Characterization of Nanocomposite Polymers” ENS'05 Paris, France, 14-16 Dec. 2005.)

Strain Gages

Strain gages are typically serpentine or coil structures that are intimately adhered to the structure under test such that when the structure surface experiences strain (deformation) the strain gage also deforms to become longer and thinner. This occurs through plastic and elastic deformation of the gage structure. (It is the common industry practice to use the “gage” spelling rather than “gauge” for historical reasons, but both can be found in the literature.) The resistance, R, of a metal article of uniform cross sectional area, A, is defined as

R=ρ×l/A (4)

where ρ is the electrical resistivity (also known as specific electrical resistance or volume resistivity) of the metal and l is the length. A stretched wire or gage will have higher resistance because the length goes up and the cross-sectional area goes down. Thus, a constant applied voltage across such a gage will experience a detectable change in current by Ohm's law.

I=V/R. (5)

The ductility, elasticity and resistivity of a metal article depend on the physical properties of the article in a variety of ways from the simple atomic composition to the physical form of the article. If the resistivity, p, remains constant, then this is an easily calibrated device. However, at high temperatures the physical properties such as the grain structure and even composition of the metal may not remain constant thereby changing the ductility, elasticity and resistivity.

Conventional high temperature strain gages have been developed to avoid high temperature grain boundary motion, principally by alloying high melting point noble metals with a small quantity of another refractory metal, preferably one with a higher melting temperature. As is well understood by those knowledgeable in the art and as discussed above, the alloying element “hardens” the alloy and reduces ductility and grain boundary motion.

Commercial high temperature hardened wire strain gages are available in both free filament and weldable form. Free-filament gages can be adhered to the article under test using refractory ceramic cement or by the method of flame spraying using ceramic rod or powder. Such wire or foil strain gages are limited in sensitivity and resolution by the gage medium thickness and method of application.

Pt—W wire strain gages are rated to 1038° C. These gages use Pt—Ni lead wires. These two alloys are known to have some of the highest response of Vickers hardness to alloying.

Temperature Sensing

Accurate strain gage readout at high and varying temperatures also requires temperature sensing for calibration. Temperature sensing can effectively be done by a number of methods, but thermocouples and resistance sensors such as resistance temperature devices (RTDs) and thermistors are the dominant technologies.

High temperature wire thermocouples are well known, most commonly some combination of Pt and PtRh alloys, but also as a Pt—Au pair. Such wire thermocouples are limited in sensitivity and resolution by the wire thickness and method of application. Pt—Pt90%:Rh10% (Type S) and Pt-Pt87%:Rh13% (Type R) thermocouples are accurate from 0 to 1400° C. while Pt94%:Rh6%-Pt70%:Rh30% (Type B) is useful over a range 800-1700° C. Pt—Au wire thermocouples are deemed the most accurate from 0 to 1000° C., but are seldom used. Unalloyed Pt and Au wires can be subject to drift due to recrystallization and agglomeration at high temperature and typically require mechanical support from two-hole alumina thermocouple tubing, external sheaths and other such means.

At room temperature, resistance devices including platinum and nickel RTDs and thermistors made of semiconducting oxides are conventionally the most accurate temperature sensing technology and can potentially be read out wirelessly. However, semiconducting thermistor materials are limited to use at lower temperatures. Platinum RTDs can also be subject to grain growth and property changes at sufficiently high temperatures.

The prior art technologies of making strain gages and thermocouples with discrete wires have distinct limitations in direct application/integration to large three-dimensional (3D) parts, weight, resolution, feature size and profile.

Photolithographic Methods

Strain gages can also be made by high technology photolithographic methods requiring a rigid, planar framework and clean room environment for the entirety of the production. These requirements in turn limit the deposition of such strain gages on large complex 3D parts. Even more than wires, sputtered and evaporated platinum thin film electrodes experience morphological changes from agglomeration, recrystallization and dewetting above 700° C. that can change the device characteristics of strain gages and thermocouples and even result in complete failure because of continuity breaks. Sputtered alloys containing other refractory metals exhibit improved high temperature performance for reasons as discussed for wires.

Sputtered high temperature PdCr strain gages that are nominally stable against corrosion and grain growth have been developed. (J. F. Lei and H. A. Will, “Thin-Film Thermocouples and Strain-Gauge Technologies for Engine Applications,” Sensors and Actuators A 65 (1998) 187.) The apparent strain sensitivity of a PdCr static strain gage is approximately 85 με° C.⁻¹ when connected to a Wheatstone-bridge circuit in a half-bridge configuration. It is stable and repeatable to within ±200με (microstrains) between thermal cycles to 1100° C. with sensitivity better than 3.5 με° C.⁻¹ in the entire temperature range. Such devices require clean room preparation, photolithography and other extensive procedures.

Similar to strain gages, thin film thermocouples can also be made by high technology photolithographic methods requiring a rigid, planar substrate and clean room environment for the entirety of the production. Alloying Pt or Au is not an option for thermocouple applications because it will change the thermoelectric effect.

The prior art technologies of making strain gages and thermocouples using photolithography and vapor phase deposition techniques in a clean room environment have distinct limitations in direct application/integration to large 3D parts, cost and processing time.

Direct-Write Printing

As technology continues to produce smaller, cheaper, lighter and more intricate and integrated systems, they cannot always be supported by conventional processing techniques. Direct-write (DW) printing is an additive manufacturing technology in which material is deposited in layers to produce desired features. DW is used for direct printing of functional electronic circuitry, components and sensors onto flexible, low temperature, and non-planar surfaces without any special tooling. Direct-write printing has established itself as an enabling technology for production of both circuits and sensors directly on 3D and flexible surfaces that could not otherwise be fabricated with conventional techniques. This approach is distinctly different from traditional subtractive manufacturing methods where large area deposition, photolithographic chemicals, and toxic etchants are used to remove material to obtain the target pattern. By using a three-dimensional additive manufacturing approach, systems can have improved integration, smaller packaging footprints, fewer steps, less waste, reduced weight, and lower fabrication costs.

An aerosol of fine ink droplets is created by pneumatic or ultrasonic methods and propelled in a nitrogen gas stream onto the substrate. The Aerosol Jet (AJ) process utilizes an aerodynamic focusing technique to collimate this dense aerosol mist of material-laden micro-droplets into a tightly controlled beam of material that can produce features as small as 10 μm or as large as several centimeters. Coupled with a motion control system that moves either the print-head or the substrate, high resolution patterns can be created using computer aided design (CAD) based-programs to produce distinctive features as well as wide area conformal coatings. Commercially available Aerosol Jet print-heads can comfortably print feature sizes down to 10 μm with optimization and are capable of depositing high viscosity (up to 1000 cP), high particle loading (up to 70 wt %), wide viscosity range inks well beyond the range of conventional inkjet printing. One of the most advanced characteristics is the non-contact deposition, enabling traces to be printed over steps, curved surfaces, and conformally on 3D objects while printing with a nominal standoff distance of up to 3-5 mm. With process optimization, successful deposition has been demonstrated up to a 10 mm standoff.

The nature of AJ deposition is that nanoparticle inks are required to form a good aerosol. Other direct write additive techniques that use nanoparticle inks include ink-jet printing, pneumatic micro-dispensing, and syringe dispensing.

Metal Nanoparticle Inks

Metal nanoparticles are made into an ink by dispersing them in a solvent with other additives as needed. The only prior art metal nanoparticle inks that are commercially available are single element inks. Commercially available metal nanoparticle inks include Ag, Au, Ni, Al, and Cu inks and development quantities of Pt and W inks are available. Metal nanoparticles are made from hydrocarbon precursors reacted by various methods to achieve nanoparticles of uniform size as required for low porosity when printed in an ink. (Y. Didenko and Y. Ni, U.S. Pat. No. 8,211,205 B1, Jul. 3, 2012.) Additionally, metal nanoparticles can be made by spark source generation. Previously there have been no commercial metal alloy nanoparticle inks, thus requiring innovation in synthesis and a motivating application as described further herein.

Screen Printing Metal Inks

Additional printing methods that can be used to print precious and refractory metal inks include screen printing and roll-to-roll methods. Precious metal screen printing inks are made with larger sized particles in the micron range because nanoparticles do not work properly in screen printing. Commercially available inks include precious metals such as silver, gold and platinum, but do not include any inert particulate additives. So-called thick film inks are referred to as pastes because they have much higher viscosities, but these are still fundamentally inks with metal particles in a solvent with additives. The paste loading factors are much higher than nanoparticle inks.

Metal-Organic Decomposition (MOD) Inks

To overcome the printing process limitations imparted by particle-based dispersions, solution-phase inks have been developed in a number of university laboratories that produce metal conductive traces on thermal activation that evaporates the solvent and decomposes the metal organic complex to leave a pure metal. These are known as reactive or metal-organic-decomposition (MOD) inks. Metal MOD ink technologies primarily vary by the ligands used to solubilize and stabilize the metal precursor. Early work has involved using silver carboxylate soaps that are soluble in organic solvent systems optimized for ink jet printing. However, this work has not comprised any work in platinum, gold, any alloy or any ink including inert constituents intended to provide inclusions.

Therefore, there is an unfilled inventive need for inks capable of printing film and other articles that are hardened against grain boundary motion and property variation at high temperature.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, the present application provides a refractory metal ink comprising a refractory metal species and a solvent, wherein the refractory metal ink is configured to form an alloy that is hardened against grain boundary motion when the solvent is removed.

In certain embodiments, the refractory metal species is selected from the group consisting of:

nanoparticles comprising two or more refractory metals selected from the group consisting of platinum, gold, palladium, silver, rhodium, iridium, nickel, tungsten, chromium, rhenium, and molybdenum;

two or more types of refractory metal nanoparticles selected from the group consisting of platinum nanoparticles, gold nanoparticles, palladium nanoparticles, silver nanoparticles, rhodium nanoparticles, iridium nanoparticles, nickel nanoparticles, tungsten nanoparticles, chromium nanoparticles, rhenium nanoparticles, and molybdenum nanoparticles;

two or more refractory metal organic species comprising a metal center and an organic ligand coordinated with the metal center, wherein the metal center is selected from the group consisting of a platinum atom or group of platinum atoms, a gold atom or group of gold atoms, a palladium atom or group of palladium atoms, a silver atom or group of silver atoms, a rhodium atom or group of rhodium atoms, an iridium atom or group of iridium atoms, a nickel atom or group of nickel atoms, a tungsten atom or group of tungsten atoms, a chromium atom or group of chromium atoms, a rhenium atom or group of rhenium atoms, and a molybdenum atom or group of molybdenum atoms; and

combinations thereof.

In another aspect, the present application provides an article at least partially deposited from a refractory metal ink according to any embodiments discloser herein.

In certain embodiments, the article comprises one of the group consisting of a metal alloy and an inclusion of a solid non-metal particle and wherein the article is hardened against high-temperature grain boundary motion.

In another aspect, the present application provides a method of making a patterned article comprising:

depositing a refractory metal ink as disclosed herein on a substrate in a pattern; and

curing the deposited refractory metal ink to provide a patterned article.

In another aspect, the present application provides

In another aspect, the present application provides a system for depositing refractory metal inks of the present application. In certain embodiments, the system comprises a reservoir comprising a refractory metal ink as disclosed herein; and a carrying unit operative to carry the refractory metal ink to a nozzle.

### DESCRIPTION OF THE DRAWINGS

The patent or application file contains at least one drawing executed in color. Copies of this patent or patent application publication with color drawing(s) will be provided by the Office upon request and payment of the necessary fee.

The foregoing aspects and many of the attendant advantages of this invention will become more readily appreciated as the same become better understood by reference to the following detailed description, when taken in conjunction with the accompanying drawings, wherein:

FIG. 1: Phase diagram of Pt—Au showing a spinodal at 1260° C. (H. Okamoto and T. B. Massalski “The Au—Pt (Gold-Platinum) System” Journal of Phase Equilibia 6 (1985) 46). The crystal structure of platinum is face-centered cubic (FCC). Other FCC metals can readily form continuous FCC solid solutions as is seen for Au—Ag. If cooled slowly, compositions in the middle of the phase diagram can experience spinodal decomposition into two FCC phases, but for low Au concentrations, there is just a single FCC solid solution.

FIG. 2: Vegard's Law linear fit of lattice parameter of colloidal FCC Pt—Au solid solution particles. (G. C. Bond, “The Electronic Structure of Platinum-Gold Alloy Particles,” Platinum Metals Rev. 51 (2007) 63.)

FIG. 3: Effect of alloying various metals into platinum on the Vickers hardness. (T. Biggs, S. S. Taylor and E. van der Lingen, “The Hardening of Platinum Alloys for Potential Jewelry Application” Platinum Metals Rev. 49 (2005) 2.) W and Ni are the most effective in increasing hardness, though grain boundary mobility may not correlate exclusively with hardness.

FIG. 4: Phase diagram of Pt—W showing γ and ε phases and transition from FCC to BCC with increasing W. (B Predel “Pt—W” Subvolume I ‘Ni—Np—Pt—Zr’ of Volume 5 ‘Phase Equilibria, Crystallographic and Thermodynamic Data of Binary Alloys’ of Landolt-Bornstein—Group IV Physical Chemistry. Landolt-Bornstein—Group IV Physical Chemistry, Springer Berlin Heidelberg (1998).) BCC metals such as tungsten have a more complex phase diagram in solution in FCC platinum.

FIG. 5: Graphical illustration of lattice parameter as a function of tungsten percentage in PtW alloys. The FCC structures of the Pt-rich solid solutions have a more complex lattice parameter behavior, in this case apparently quadratic. For small tungsten additions, there will be a simple FCC solid solution. (H. L. Luo, “Superconductivity and lattice parameters in face-centered cubic Pt—W and Pd—W solid solutions,” Journal of the Less Common Metals 15 (1968) 299.)

FIG. 6: Illustration of a system in accordance with embodiments disclosed herein.

FIG. 7: Grain size as a function of annealing temperature for various platinum alloy inks compared to pure Pt, in accordance with embodiments disclosed herein.

FIG. 8: Photograph of a printed thick film platinum strain gage on a YSZ substrate using screen printing commercial thick paste technology.

FIG. 9: Grain size as a function of annealing temperature for silver composite inks compared to pure Ag, in accordance with embodiments disclosed herein.

FIGS. 10A and 10B: (FIG. 10A) Silver strain gage on aluminum with polyimide insulators. (FIG. 10B) Silver strain gage on aluminum with YSZ insulator.

FIGS. 11A-11C: Strain gage test results for commercial silver screen print ink with YSZ added cured at 300° C. (FIG. 11A) The first graph is the applied load in ft-lb, (FIG. 11B) the second is the initial result and (FIG. 11C) the third is a repeat result. The responses [Ω] are at a low 5 Hz sampling rate, which results in a somewhat noisy signal. The gage factors (GF) are 2.4. Typical commercial strain gages have GF approximately equal to 2.

FIG. 12: Linear Seebeck effect response of a silver-YSZ:nickel-PVP composite thermocouple with a room temperature cold junction at 28° C.

FIGS. 13A and 13B: Aircraft model with printed silver strain gages and silver (bright)-nickel (dark) thermocouples. The nickel pads are staggered from the silver to prevent shorting. (FIG. 13A) Aerosol Jet printing of the silver pattern with nickel already in place, (FIG. 13B) underside of model with serpentine strain gages (bottom of wing right and left) and four thermocouples at the leading edges of the wings.

FIG. 14: Platinum nanoparticle ink test samples AJ printed two (“2L”), three (“3L”) and four layers (“4L”) thick on a thin flexible YSZ substrate.

FIGS. 15A, 15B, 15C, and 15D: Various types of reformer pigtail configurations, useful in accordance with embodiments disclosed herein. Reformer tubes are high temperature stainless steel tubes with an operating range to 800-871° C. and 5-8 MPa. Smaller nickel-iron-chromium Incoloy alloy tubes are used to transfer syngas (synthesis fuel gas precursor mixture for synthetic natural gas) from the reformer to the manifold. They are called pigtails because of the convoluted geometries required to accommodate thermal expansion. The pigtails are particularly at risk for deformation and failure from creep rupture, creep fatigue at terminal welds, creep fatigue cracking at bends, overheating and environmental attack, e.g., nitriding.

FIG. 16: A multi-disciplinary smart sensor solution for structural health monitoring of aircraft loads and structural responses during different flight stages and missions comprising a printed skin for aircraft and spacecraft sensing and testing including sensor design, embedded systems, functional materials, additive manufacturing and wind tunnel testing. New smart sensor technologies and approaches are used to replace conventional instrumentation and testing methods with smart materials that can be embedded into or deposited onto the structure by additive manufacturing. High temperature sensing and connector technology is required for hypersonic aircraft as pictured. The methods, refractory metal inks, and systems disclosed herein are suitable to instrument not only hypersonic wind tunnel aerodynamic testing models but also to be implemented on hypersonic flying structures.

FIG. 17 depicts an exemplary system in accordance with embodiments disclosed herein.

FIG. 18 depicts an exemplary system in accordance with embodiments disclosed herein comprising a controller operatively coupled and configured to control various components of the system.

FIG. 19 depicts an exemplary system in accordance with embodiments disclosed herein comprising a plurality of heating elements.

FIGS. 20A and 20B are schematic illustrations of refractory metal inks in accordance with embodiments disclosed herein deposited on a surface to provide a patterned article.

FIG. 21 is a phase diagram of gold silver alloys.

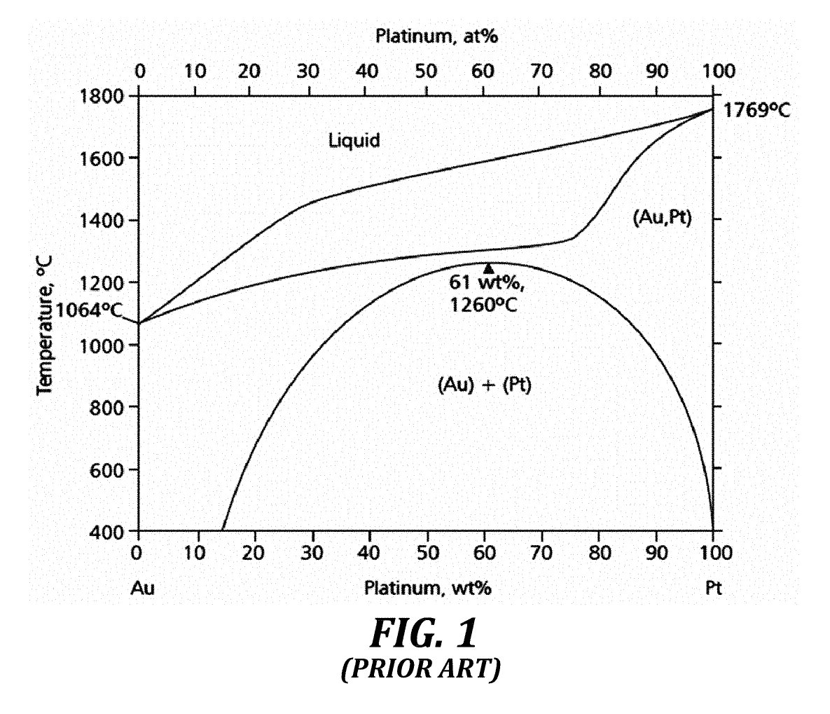

### DETAILED DESCRIPTION

Given the limitations of bulk wire technology and multi-step photolithographic clean-room fabrication techniques, a higher level of integration of sensors with complex 3D articles is desired and made possible by the disclosed embodiments. In certain aspects, the present application addresses the formulation of high-temperature-hardened inks for use in innovative additive manufacturing technologies applicable to sensors for Non-Destructive Evaluation (NDE), Structural Health Monitoring (SHM), and condition/process monitoring and control (PMC). In certain embodiments, the present application addresses the formulation of inks useful in additive manufacturing of components such as hardened ultra-high temperature lightweight strain gages and thermocouples. By development of such inks and their use in additive deposition and processing operations, fully integrated and modular sensors can be implemented for NDE, SHM, and PMC of complex parts and hard-to-address locations that were previously impossible. The successful development of high temperature sensors opens new ways to control and monitor thermal and structural loads in high temperature environments. Because of their light weight, printed ultra-high temperature sensors of the disclosed embodiments can be deposited on multiple points, creating sensing arrays to monitor large areas without imposing a weight penalty on the system.

It is advantageous for direct write printing of hardened articles, such as strain gages and thermocouples, to have an ink or inks that form a solid metal wherein grain boundary motion is restricted. This is commonly done in bulk metals by alloying or incorporating refractory inclusions that pin the grain boundaries.

Prior art metal nanoparticle inks that are commercially available are single element non-alloy inks with no intended non-metal refractory inclusions. They include Ag, Au, Ni, and Cu inks and development quantities of Pt and W inks. Metal nanoparticles are commonly made by solution methods from hydrocarbon precursors that are reacted by various methods to achieve metal nanoparticles of uniform size as is required for low porosity when printed in an ink, but can also be formed by spark discharge and other vapor phase or electrochemical methods. None of the previously developed inks contain non-metallic refractory nanoparticles that will become inclusions in the printed article to pin grain boundary motion.

Refractory Metal Inks Configured to Form an Alloy

Accordingly, in one aspect the present application provides a refractory metal ink comprising a refractory metal species and a solvent, wherein the refractory metal ink is configured to form an alloy that is hardened against grain boundary motion when the solvent is removed.

In certain embodiments, the refractory metal species is selected from the group consisting of:
a. nanoparticles comprising two or more refractory metals selected from the group consisting of platinum, gold, palladium, silver, rhodium, iridium, nickel, tungsten, chromium, rhenium, and molybdenum;
b. two or more types of refractory metal nanoparticles selected from the group consisting of platinum nanoparticles, gold nanoparticles, palladium nanoparticles, silver nanoparticles, rhodium nanoparticles, iridium nanoparticles, nickel nanoparticles, tungsten nanoparticles, chromium nanoparticles, rhenium nanoparticles, and molybdenum nanoparticles;
c. two or more refractory metal organic species comprising a metal center and an organic ligand, wherein the metal center is selected from the group consisting of a platinum atom or group of platinum atoms, a gold atom or group of gold atoms, a palladium atom or group of palladium atoms, a silver atom or group of silver atoms, a rhodium atom or group of rhodium atoms, an iridium atom or group of iridium atoms, a nickel atom or group of nickel atoms, a tungsten atom or group of tungsten atoms, a chromium atom or group of chromium atoms, a rhenium atom or group of rhenium atoms, and a molybdenum atom or group of molybdenum atoms; and
d. combinations thereof.

As used herein, “hardened against grain boundary motion” refers to a metal article comprising grains comprising alloying, segregation, phase separation, and/or inclusion of particles, in which the motion of atoms between two or more grains is restricted relative to grains in an article comprising no such alloying, segregation, phase separation, and/or inclusion of particles at the grain boundary. The motion of grain boundary motion can be measured by the change in grain size of the film as measured by x-ray diffraction linewidth following heat treatment at a given temperature.

Refractory Metal Inks Comprising Two or More Types of Metal Nanoparticles

In certain embodiments, the refractory metal species include two or more types of refractory metal nanoparticles. By including two or more types of refractory metal nanoparticles in the refractory metal inks, a deposited metal article made from such a refractory metal ink will include alloys derived from the two or more types of refractory metal nanoparticles. Such alloys will occur, for example, at grain boundaries present in the deposited metal article, which, as described further herein, harden the article against grain boundary motion.

Metal nanoparticles “melt”, i.e. react and sinter, at much lower temperatures than bulk material because surface transport is dependent on radius of curvature and there is a strong driving force to eliminate surface energy. For very small and uniform nanoparticles this is especially so. Moreover, because of the high temperature substrate and application of these devices, higher than normal curing/sintering temperatures can be used. Therefore, processing conditions can be achieved such that the mixed metal nanoparticles are sufficiently alloyed to pin the grain boundaries.

Accordingly, in certain embodiments, the refractory metal species comprises particles having a mean diameter between about 1 nm and about 100 nm. In certain further embodiments, the refractory metal species comprises nanoparticles having a mean diameter between about 2 nm and about 50 nm. In certain further embodiments, the refractory metal species comprises nanoparticles having a mean diameter between about 2 nm and about 20 nm. In certain further embodiments, the refractory metal species comprises nanoparticles having a mean diameter between about 2 nm and about 10 nm.

In certain embodiments, the refractory metal particles comprise two or more types of refractory metal nanoparticles selected from the group consisting of platinum nanoparticles, gold nanoparticles, palladium nanoparticles, silver nanoparticles, rhodium nanoparticles, iridium nanoparticles, nickel nanoparticles, tungsten nanoparticles, chromium nanoparticles, rhenium nanoparticles, and molybdenum nanoparticles. In certain embodiments, the refractory metal species comprises nanoparticles comprising two or more refractory metals and excludes the combination of platinum and rhodium.

In certain embodiments, the two or more types of refractory metal nanoparticles are intimately mixed. Simple mixing of two single-element nanoparticles has been shown to result in an alloy on curing at moderate temperatures, as shown further herein in the examples below. Mixing of single-element inks provides a mixture of metal nanoparticles capable of being alloyed by heat treating. For example, Pt ink is mixed with 5-15% Au, Ni, W, or Rh ink with the same solvent basis so that blends between them are readily made.

In certain embodiments, nanoparticles comprise a surfactant on a surface of the nanoparticle. For metal nanoparticles comprising a surfactant, an ashless surfactant is advantageous because these nanoparticles may be taken to very high temperatures in use where any organic will combust/vaporize. Any remaining ash or organic matter will limit electrical conduction and ultimate device performance.

Alloy Particles

In certain embodiments, the refractory metal inks comprise refractory metal species, wherein the refractory metal species are particles comprising an alloy of two or more refractory metals. When refractory metal inks comprising particles comprising an alloy of two or more refractory metals are deposited on a substrate and form a deposited metal article the particles sinter, grains are formed, and phase segregation and separation occurs at grain boundaries sufficient to pin the grain boundaries. Such deposited metal articles are, as above, hardened against grain boundary motion.

In certain embodiments the refractory metal species are nanoparticles formed from an alloy of two or more refractory metals. In certain embodiments, the refractory metal species are nanoparticles formed from an alloy of two or more refractory metals selected from the group platinum, gold, palladium, silver, rhodium, iridium, nickel, tungsten, chromium, rhenium, and molybdenum. In certain embodiments, the metal alloy nanoparticles are formed by a method selected from co-reacting precursors and spark discharge generation

In certain embodiments, the refractory metal species comprises a majority metal constituent and a minority metal constituent different from the majority metal constituent, wherein the majority metal constituent has a concentration greater than or equal to 60% by weight of the total metal species and the minority metal constituent has a concentration less than or equal to 40% by weight of the total metal species. In certain embodiments, the majority species has a concentration greater than or equal to 70% by weight of the total metal species. In certain embodiments, the majority species has a concentration greater than or equal to 80% by weight of the total metal species. In certain embodiments, the majority species has a concentration greater than or equal to 90% by weight of the total metal species. In certain embodiments, the majority species has a concentration greater than or equal to 95% by weight of the total metal species. In certain embodiments, the majority species has a concentration greater than or equal to 96%, 97%, 98%, or 99% by weight of the total metal species.

In certain embodiments, the majority metal constituent is a metal selected from the group consisting of platinum, gold, palladium, silver and nickel. In certain embodiments, the majority species is platinum. In certain embodiments, the minority metal constituent is a metal selected from the group consisting of rhodium, gold, palladium, and iridium.

In certain embodiments, the refractory metal species comprises a majority metal constituent and a minority metal constituent different from the majority metal constituent, wherein the majority metal constituent comprises a metal selected from the group consisting of platinum, gold, palladium, silver and nickel with a concentration greater than or equal to 60% by weight of the total metal species and the minority metal constituent comprises a metal selected from the group consisting of rhodium, gold, palladium and iridium with a concentration less than or equal to 40% by weight of the total metal species. These minority constituents have negative or low positive pOs and, therefore, can be accommodated in relatively high concentrations without risk of oxidation.

In certain embodiments, the refractory metal species comprises a majority metal constituent and a minority metal constituent different from the majority metal constituent, wherein the majority metal constituent comprises a metal selected from the group consisting of platinum, gold, palladium, silver, and nickel with a concentration greater than or equal to 85% by weight of the total metal species and the minority metal constituent comprises metals selected from the group consisting of nickel, tungsten, chromium, rhenium, and molybdenum with a concentration less than or equal to 15% by weight of the total metal species. These minority constituents have higher positive pOs and therefore are accommodated in lower concentrations to avoid oxidation. In certain embodiments, the majority metal constituent is platinum and has a concentration of greater than or equal to 85%. In certain embodiments, the majority metal constituent is platinum and has a concentration of greater than or equal to 90%. In certain embodiments, the majority metal constituent is platinum and the minority metal constituent is selected from the group consisting of rhodium, tungsten, and nickel.

In such alloyed nanoparticle refractory metal inks it is advantageous to select majority and minority metal constituents and their relative proportions to retain as much as possible the positive features of the majority metal constituent such as high melting temperature, low tendency of oxidation, and low susceptibility to corrosion. Alloys among two low oxidation potential metals are less likely to oxidize and therefore permit a higher concentration of the alloying element.

In another aspect, nanoparticles that are alloys at the atomic level are made by co-reacting a mixture of precursors of the two or more elements desired for the alloy so as to create nanoparticles alloyed at the atomic level. Once the nanoparticles are achieved, they are made into an ink comprising a solvent. In certain embodiments, the refractory metal ink further comprises a dispersant, a surfactant, and other components as needed. Alternatively, in another aspect, alloy nanoparticles are made by spark source generation from alloy feedstock, continuous liquid-flow aerosol and other methods.

In certain embodiments, the refractory metal species comprise refractory metal alloy particles between 100 nm and 50 μm in diameter composed of two or more refractory metals selected from the group platinum, gold, palladium, silver, rhodium, iridium, nickel, tungsten, chromium, rhenium, and molybdenum, excluding combinations of platinum and rhodium.

Like the refractory metal inks comprising nanoparticles comprising an alloy of two or more refractory metals, refractory metal inks comprising refractory metal alloy particles between 100 nm and 50 μm in diameter composed of two or more refractory metals form deposited metal articles hardened against grain boundary motion. Similarly, such deposited metal articles are hardened against grain boundary motion because the deposited inks form grain boundaries comprising alloys and, accordingly, segregation and phase separation sufficient to pin the grain boundary.

Precious metal alloy microparticles such as Pt92%-Ni8%, Ag50%-Pd50%, Ag90%-Pt10% can be formed by mechanical or electrochemical methods and formed into an ink. Microparticle inks are suitable for screen printing if the particle size is matched to the mesh size.

In certain embodiments, the refractory metal alloy particles composed of two or more refractory metals have a mean diameter between about 100 nm and about 50 μm. In certain embodiments, the refractory metal alloy particles composed of two or more refractory metals have a mean diameter between about 200 nm and about 10 μm. In certain embodiments, the refractory metal alloy particles composed of two or more refractory metals have a mean diameter between about 300 nm and about 1 μm. In certain embodiments, the refractory metal alloy particles composed of two or more refractory metals have a mean diameter between about 500 nm and about 1 μm.

Metal-Organic Decomposition (MOD) Alloy Inks

In certain embodiments, the refractory metal ink comprises two or more refractory metal organic species each comprising a metal center and an organic ligand coordinated with the metal center. In certain embodiments, the organic ligands are configured to stabilize the metal center and promote and/or amplify metal reduction when subjected to thermal and/or photonic energy. When a refractory metal ink comprising two or more refractory metal organic species each comprising a metal center and an organic ligand coordinated with the metal center is deposited and subjected to thermal and/or photonic energy the metal center is reduced and forms a deposited metal article. Such a metal article is an alloyed metal article and, accordingly, forms grains and grain boundaries comprising phase segregation and separation sufficient to pin grain boundary motion.

In certain embodiments, the metal center is selected from the group consisting of a platinum atom or group of platinum atoms, a gold atom or group of gold atoms, a palladium atom or group of palladium atoms, a silver atom or group of silver atoms, a rhodium atom or group of rhodium atoms, an iridium atom or group of iridium atoms, a nickel atom or group of nickel atoms, a tungsten atom or group of tungsten atoms, a chromium atom or group of chromium atoms, a rhenium atom or group of rhenium atoms, and a molybdenum atom or group of molybdenum atoms. In certain embodiments, the organic ligand comprises an electron donating group and an aliphatic tail. In certain embodiments, the electron donating group comprises an atom selected from the group consisting of an oxygen atom or atoms, a nitrogen atom or atoms, and a phosphorus atom or atoms.

The general reaction scheme for the conversion of a metal organic precursor to a metal trace is shown in chemical Equation (6),

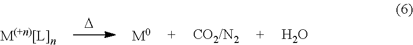

where L represents hydrocarbon ligand(s) containing either nitrogen and/or oxygen as the electron donating group, M represents the transition metal undergoing reduction, and n is the number of positive charges on the transition metal and the number of coordinating ligands, in the case of monodentate ligands. Metal reduction is driven by ligand combustion in the absence of oxygen. As reduction proceeds, the metal nucleates into its characteristic crystalline structure. Selected ink additives are introduced not only to optimize required printing process parameters, such as viscosity and surface tension, but also to stabilize the metal formation process, and protect against air oxidation.

Targeted transition metal complexes have been synthesized using ligands that stabilize the transition metal and also promote and amplify metal reduction when subjected to thermal and/or photonic energy. Ligands are selected that are tuned to the process of photonic curing, thereby providing a production pathway that is both rapid and efficient. Ink additives and reduction promotion chemistry have also been formulated into the ink solvent further enhancing the metal reduction efficiency. Ink vehicles are optimized for the selected printing platform. Ink jet and aerosol jet print processes have been adopted as high-speed production processes where high precision pattern deposition is required. For screen printing, the inks are formulated with ink vehicles that have higher viscosity and solid loading compositions than those used in digital printing. The metal MOD complex chemistry dictates which ink vehicles are selected for a particular printing process.

Nanoparticle and MOD inks are suitable for aerosol jet and inkjet printing among other technologies.

Refractory Metal Inks Comprising Non-Metal Particles

In one embodiment, the present application provides a refractory metal ink comprising a refractory metal species, non-metal particles, and a solvent, wherein the refractory metal ink is configured to form a metal article hardened against high-temperature grain boundary motion by incorporation of the solid non-metal particles when the solvent is removed. As described herein, inclusion of particles, such as non-metal particles, prevents grain boundary motion by requiring that the grain boundary either move the inclusion with it or move around it.

Such inks can be made, for example, 1) by inclusion of non-metallic particles directly during the formulation of the metal particle ink with additional dispersant to account for the added solids loading and 2) formulation of a non-metal particle ink and mixing of the two. The first method is simpler, but the latter method is preferred if the two types of nanoparticles react, demix, or segregate. It will be understood by those knowledgeable in the art that the source of the refractory metal species can vary and the size of the non-metal particles should be commensurate with the size of the metal particles either as they exist in the ink (metal nanoparticles and microparticles) or as they form by reaction (metal organic decomposition inks).

In certain embodiments, the non-metal particles comprise materials selected from the group consisting of aluminum oxide, zirconium oxide, yttrium oxide, cerium oxide, silicon oxide, yttria stabilized zirconia, silicon carbide, graphite, carbon nano-tubes, diamondoid, organic compounds that ash to carbon species when fired at high temperature, and combinations thereof.

In certain embodiments, the non-metal particles are nanoparticles. In certain embodiments, the non-metal particles are solid non-metal particles. In certain embodiments, the non-metal nanoparticles include nano-diamonds, diamondoids (hydrogen terminated nano-diamonds, e.g. diamantane C₁₄H₂₀ CAS#2292-79-7), zirconium oxide nanoparticles (ZrO₂, zirconia), yttrium oxide nanoparticles (Y₂O₃, yttria), yttria-stabilized zirconia nanoparticles (YSZ), cerium oxide nanoparticles (CeO₂, ceria), aluminum oxide nanoparticles (Al₂O₃, alumina), silicon oxide nanoparticles (SiO₂, silica), silicon carbide nanoparticles (SiC) and other high temperature stable non-metal compounds that do not interact chemically with the metallic particles of the ink.

Carbon-based compounds such as graphite have the positive aspect of being reducing agents and preventing oxidation of ink species during firing in air. Organic compounds, such as polyvinyl pyrrolidone (PVP), that ash to carbon species can serve the same function.

In certain embodiments, non-metal particles are not soluble in a metal formed from the refractory metal species. When the non-metal particles are not soluble with a metal formed from the refractory metal species, the non-metal particles remain as inclusions in the metal, rather than as an alloying agent. As above, such inclusions aid in hardening an article formed from the refractory metal inks according to certain embodiments disclosed herein against grain boundary motion.

In certain embodiments, the non-metal particles do not react with a metal formed from the refractory metal species at high temperature. If the non-metal particles were to react with the refractory metal species at high temperature a metal formed from the refractory metal inks disclosed herein might convert to another non-metal species, thereby obviating or deteriorating their use in making conductive devices such as, for example, strain gages.

In certain embodiments, the refractory metal species comprise one or more types of refractory metal nanoparticles selected from the group consisting of platinum nanoparticles, gold nanoparticles, palladium nanoparticles, silver nanoparticles, rhodium nanoparticles, iridium nanoparticles, nickel nanoparticles, tungsten nanoparticles, chromium nanoparticles, rhenium nanoparticles, and molybdenum nanoparticles. In certain embodiments, the refractory metal species comprises particles having a diameter between about 100 nm and about 50 μm. In certain further embodiments, the refractory metal species comprises nanoparticles having a diameter between about 200 nm and about 800 nm. In certain further embodiments, the refractory metal species comprises nanoparticles having a diameter between about 300 nm and about 700 nm. In certain further embodiments, the refractory metal species comprises nanoparticles having a diameter between about 400 nm and about 600 nm.

For metal nanoparticles comprising a surfactant, an ashless surfactant is advantageous because these nanoparticles may be taken to very high temperatures in use where any organic will combust/vaporize. Any remaining ash or organic matter will limit electrical conduction and ultimate device performance. Exceptions include when the ash is intended as a non-conducing particle, such as a non-metal particle that forms an inclusion in a printed article, or as a reducing agent.

In certain embodiments, the refractory metal species comprises nanoparticles comprising an alloy of two or more refractory metals selected from the group consisting of platinum, gold, palladium, silver, rhodium, iridium, nickel, tungsten, chromium, rhenium, and molybdenum, as described further herein above.

In certain embodiments, the refractory metal species comprise one or more refractory metal organic species comprising a metal center and an organic ligand coordinated with the metal center. In certain embodiments the metal center is selected from the group consisting of a platinum atom or group of platinum atoms, a gold atom or group of gold atoms, a palladium atom or group of palladium atoms, a silver atom or group of silver atoms, a rhodium atom or group of rhodium atoms, an iridium atom or group of iridium atoms, a nickel atom or group of nickel atoms, a tungsten atom or group of tungsten atoms, a chromium atom or group of chromium atoms, a rhenium atom or group of rhenium atoms, and a molybdenum atom or group of molybdenum atoms.

In another aspect, the refractory metal species in the inclusion hardened ink is one or more refractory metal organic species comprising a metal center and an organic ligand. In certain embodiments, the metal center is selected from the group consisting of a platinum atom or group of platinum atoms, a gold atom or group of gold atoms, a palladium atom or group of palladium atoms, a silver atom or group of silver atoms, a rhodium atom or group of rhodium atoms, an iridium atom or group of iridium atoms, a nickel atom or group of nickel atoms, a tungsten atom or group of tungsten atoms, a chromium atom or group of chromium atoms, a rhenium atom or group of rhenium atoms, and a molybdenum atom or group of molybdenum atoms. In such refractory metal inks, the non-metal particles can be initially suspended in the refractory metal ink.

In certain embodiments, the refractory metal species in the inclusion hardened ink are one or more types of refractory metal particles between 100 nm and 50 μm in diameter selected from the group platinum, gold, palladium, silver, rhodium, iridium, nickel, tungsten, chromium, rhenium, and molybdenum. Hardening of thick film pastes and other microparticle inks by non-metallic inclusions has not previously been accomplished. This type of ink is suitable for screen printing and other deposition methods.

In another aspect, the refractory metal species in the inclusion hardened ink are refractory metal alloy particles between 100 nm and 50 μm in diameter comprised of two or more refractory metals selected from the group platinum, gold, palladium, silver, rhodium, iridium, nickel, tungsten, chromium, rhenium, and molybdenum. In this case the ink is doubly hardened by alloying and inclusions.

The refractory inks disclosed herein comprise a solvent. In certain embodiments, the refractory metal inks disclosed herein further comprise one or more of the group consisting of a capping agent, a dispersant, a surfactant, and a binder.

In certain embodiments, the solvent is selected from the group consisting of ethanol, isopropyl alcohol, 1-methoxy 2-propanol, ethylene glycol, alpha-terpineol, toluene, 2-butanol, n-methyl-2-pyrrolidone (NMP), water, and combinations thereof. In certain embodiments, the solvent is a mixture of solvents with high and low vapor pressures. Non-limiting examples of solvents with high and low vapor pressure can be found in Table II.

Aerosol Jet ink formulations commonly use a co-solvent blend containing a mixture of high (>0.5 kPa @ 25° C.) and low (<0.1 kPa @ 25° C.) vapor pressure solvents such as toluene/alpha-terpineol or ethanol/ethylene glycol. Both solvents must be either polar (P′>3.0) or non-polar (P′<3.0) as defined by the Snyder Polarity Index, P′. Typically, the higher vapor pressure solvent evaporates while the ink is being atomized, thus increasing the solid content of the ink droplets in flight. The lower vapor pressure solvent evaporates during drying and curing after deposition. The mix ratio of the two co-solvents and the vapor pressure of the high boiling point solvent typically determines the shelf life of the ink. A dispersant and/or capping agent is advantageous to keep nanoparticles from agglomerating in solution, and adhesion promoters/surfactants are used to promote adhesion to a variety of substrates. Table II gives a list of typical high and low vapor pressure solvents.

TABLE II
High and Low Vapor Pressure Solvents.

| | | | |
|---|---|---|---|
| | | Vapor Pressure | |
| Solvent | CAS# | (kPa @ 25° C.) | P′ |

High

| | | | |
|---|---|---|---|
| Acetone | 67-64-1 | 30.8 | 5.1 |
| Hexane | 110-54-3 | 20.2 | 0.1 |
| Methanol | 67-56-1 | 16.9 | 5.1 |
| Ethanol | 64-17-5 | 7.87 | 5.2 |
| Isopropanol | 67-63-0 | 6.02 | 3.9 |
| Toluene | 108-88-3 | 3.79 | 2.4 |
| Deionized water | | 3.17 | 10.2 |
| 2-Butanol | 78-92-2 | 2.32 | 3.4 |
| 1-Methoxy 2-propanol | 107-98-2 | 1.45 | |
| o-Xylene | 95-47-6 | 0.88 | 2.5 |

Low

| | | | |
|---|---|---|---|
| n-Methyl-2-pyrrolidone (NMP) | 872-50-4 | 0.040 | 6.7 |
| Ethylene glycol | 107-21-1 | 0.010 | 6.9 |
| α-Terpineol | 98-55-5 | 0.003 | nonpolar |
| Diethylene glycol monobutyl | 112-34-5 | 0.001 | |
| ether (DEGBE) | | | |

In certain embodiments, the refractory metal ink has a characteristic selected from the group consisting of:
the solvent is a mixture of solvents with high and low vapor pressures;
the ink has a solids loading fraction between 15% and 25% by volume;
the ink has a viscosity less than 10 centipoise;
the ink has a surface tension between 30 and 55 milli-Newton per meter (dynes per centimeter); and
combinations thereof.

These are conditions found to be advantageous to produce a refractory metal ink useful in ultrasonic aerosol jet and inkjet printing. A solids loading fraction lower than 15% by volume results in poor coverage and poor conductivity. A solids loading fraction higher than 25% by volume results in a higher viscosity and, correspondingly, worse performance in aerosolization.

Viscosities higher than 10 centipoise do not allow the ink to be aerosolized by an ultrasonic atomizer. Surface tensions between 30 and 55 milli-Newtons per meter (dynes per centimeter) promote good wetting of the ink to a wide variety of substrates with varying surface energies.

Methods of Making Patterned Articles from Refractory Metal Inks

Technologies are required that enable flaw detection and Structural Health Monitoring (SHM) of petrochemical systems, aircraft, space flight vehicles, automotive, and other applications in harsh environments including temperatures to 1000° C., high vacuum, high pressure, vibration, turbulence, combustion and cryogenic conditions. Current technologies for making strain gages and thermocouples either with discrete wires or using photolithography and vapor phase deposition techniques in a clean room environment have distinct limitations in direct application/integration to large 3D parts, cost and weight/resolution/feature size. Further, such sensors permit high level condition and process monitoring with the end goal of using them for process control. By development of such inks and the related additive deposition and processing operations, fully integrated and modular sensors can be implemented for NDE, SHM, and PMC of complex parts and hard-to-address locations that were previously out-of-bounds. The successful development of high temperature sensors opens new ways to control and to monitor thermal and structural loads in critical high temperature environments. Thanks to their light weight, printed ultra-high-temperature sensors can be deposited on multiple points, creating sensing arrays to monitor large areas without imposing a weight penalty on the system.

Accordingly, in another aspect, the present application provides a method of making a patterned article comprising: depositing a refractory metal ink as disclosed herein on a substrate in a pattern; and curing the deposited refractory metal ink to provide a patterned article.

Direct Write additive manufacturing using inks of this type may be accomplished with a wide variety of technologies. In certain embodiments, the refractory metal ink is deposited on the substrate through additive manufacturing methods selected from the group consisting of aerosol jet printing, inkjet printing, micro-syringe dispense printing, screen printing, roll-to-roll printing, and combinations thereof. In certain embodiments, the refractory metal ink is deposited iteratively onto the substrate to provide a desired or preferred thickness to the ultimate patterned article. In certain embodiments, the refractory metal ink is deposited one time, two times, three times, four times, five times, or more over a particular portion of a substrate.

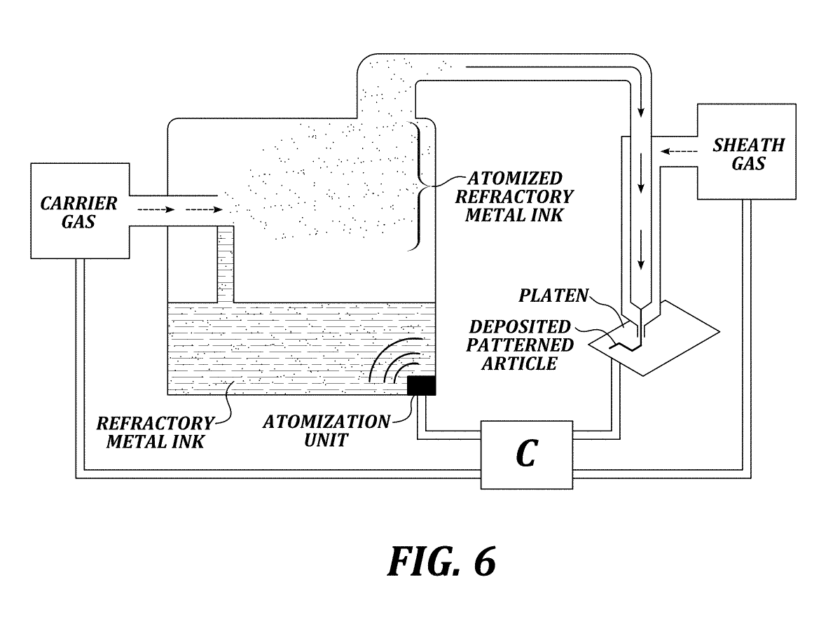

Aerosol jet (AJ) printing is depicted in FIG. 6. A unique advantage for AJ printing is that the process is non-contact, allowing for nearly any surface topography provided the surface of interest can be exposed to the nozzle. After rapid prototyping, cost reduction can be accomplished by moving to a higher volume machine/technology or in-situ deposition methods such as screen or micro-syringe dispense printing.

As technology continues to produce smaller, cheaper, lighter and more intricate and integrated systems, they cannot always be supported by conventional processing techniques. Traditional multi-step photolithographic fabrication techniques require a rigid, planar framework and clean room environment for the entirety of the production. By using a three dimensional (3D) additive manufacturing approach, systems have improved integration, smaller packaging footprints, fewer steps, less waste, reduced weight, and lower fabrication costs. Direct-write printing has established itself as an enabling technology for production of both circuits and sensors directly on 3D and flexible surfaces that could not otherwise be fabricated with conventional techniques. Aerosol Jet (AJ) is a particularly innovative technology. A key advantage for AJ is that the process is non-contact, allowing for nearly any surface topography, provided that the surface of interest can be exposed to the nozzle. Other additive technologies can be adapted for in-situ deposition and high volumes.

When depositing a refractory metal ink several deposition parameters may be taken into consideration. Such parameters can include the following:

Ultrasonic or Pneumatic Atomization—

In certain embodiments, the methods of the present application further comprise atomizing or nebulizing the refractory metal ink to provide droplets of the refractory metal ink in a gas. Doing so allows, for example, the refractory metal ink to be deposited by Aerosol Jet printing and other deposition methods. In certain embodiments, the refractory metal ink is atomized pneumatically. High viscosity refractory inks can be Aerosol Jet printed using a pneumatic atomizer. The pneumatic atomizer can atomize inks with viscosities between 100-1000 cP and work well in the range of 300-500 cP. These inks typically have a solids content of 50-70%, and hence a higher volume per unit area can be deposited with the pneumatic atomizer. The atomizing gas (in certain embodiments, high-purity nitrogen) is used as the driving gas for creating the mist. In certain embodiments, the atomizing gas has a flow rate range of 600-900 cubic centimeters per minute (ccm) to create mist pneumatically depending on the surface energy, viscosity, and solids loading of the ink being used. Since this creates a relatively dilute mist, the excess nitrogen going downstream from the atomization cup is diverted away by means of vacuum pump, called the virtual impactor, while the aerosol of ink droplets ballistically proceeds toward the deposition tube. In certain embodiments, the virtual impactor is operates in the range of 550-850 ccm gas flow, hence maintaining a flow difference of 30-50 ccm for the deposition stream impacting the substrate. The virtual impactor also acts as particle size filter, since all the ultra-small micro droplets are sucked away and the heavy larger droplets proceed without deviation leaving only an average one micron diameter range droplet to pass through to the nozzle. This reduces the possibility of clogging due to the too large droplets and over spray (stray droplets deposited outside the intended pattern) due to the too small droplets. The stream of droplets in nitrogen is further collimated by means of a sheath gas (high-purity nitrogen) that focuses the beam down to approximately one tenth the nozzle diameter being used. In certain embodiments, the sheath gas is operates between 30-70 ccm, depending, in part, on the nozzle diameter and the width of the trace needed. Higher sheath gas flow increases overspray and very low sheath flow can lead to nozzle clogging. Adding YSZ or diamantane fillers to the inks may increase the viscosity.

In certain embodiments, the refractory metal ink is atomized ultrasonically. Ultrasonic atomization can be used with relatively smaller quantities for very expensive inks. The ultrasonic atomizer is used advantageously with low-viscosity inks, with viscosities ranging, for example, from about 1 cP to about 10 cP, and with solids loading, for example, between about 1% and about 20%. A lower volume of ink is needed for this atomization process (for example about 1 ml), hence making it very cost effective for precious metal inks. In certain embodiments, the ink is atomized in a glass vial that is suspended over an ultrasonic transducer in a reservoir of water as the transduction medium. In certain embodiments, the transducer operates at about 45 Volts. The vial can be translated and pivoted over the transducer to achieve the densest atomizer mist. In certain embodiments, a 33-38 degree tilt angle and a left to right translation of 2-5 mm creates the densest mist. Once the mist is created, a low-pressure stream of carrier gas (12-25 ccm) carries the mist downstream to the printing nozzle. Since the larger droplets created settle downward back into the reservoir due to the low pressure of the carrier gas, only the moderate- and small-diameter ink droplets make it upward into the carrying unit. Hence there is no need for removal of excess gas before printing, as in the pneumatic atomizer. The stream of droplets in nitrogen is further collimated by means of a sheath gas (high-purity nitrogen) that focuses the beam down to approximately one tenth the nozzle diameter being used. In certain embodiments, the sheath gas is run between 30-70 ccm depending, in part, on the nozzle diameter and the width of the trace needed. Higher sheath gas flow increases overspray and very low sheath flow can lead to nozzle clogging.

Ink Temperature—

The viscosity of any given ink is, in part, an intrinsic property, but it also varies as a function of temperature within its working range. In certain embodiments, the refractory metal ink is heated in the reservoir. This is helpful to lower the viscosity of the ink to facilitate atomization. The atomization cup heater can be heated to between about 35° C. and about 50° C. Such heating influences how refractory metal inks aerosolize. In certain embodiments, the refractory metal ink is heated after it has been atomized, aerosolized, or nebulized to form droplets. Such heating can be accomplished with an in-line heater in a collimator and influences droplets in flight and when they strike the substrate. The ink temperature modulated by the in-line heater will influence evaporation of volatiles in flight, which can make the ink more concentrated when it hits the substrate. The inflight tube heater serves the purpose of removing some solvent from the in-flight droplets, which increases the solids content of the droplets and reduces the droplet diameter. In certain embodiments, the tube heater is typically heated to between about 30° C. and about 50° C.

Solvent Addition—

Depending upon, for example, the particular solutes of the refractory metal ink, the solvent system, and the deposition method, some refractory metal inks benefit from solvent additions immediately prior to deposition to make them more printable. Accordingly, in certain embodiments, the methods of the present application comprise providing solvent to the refractory metal ink just prior to deposition. In addition to adding a solvent directly to the ink, a volatile solvent content of the ink may be added into the ink via the carrier nitrogen gas when the refractory metal ink is being deposited by Aerosol Jet printing. Accordingly, in certain embodiments, a carrier gas further comprises a solvent of the refractory metal ink. However this can alter the concentration and viscosity of the ink over time, thereby changing the printed feature quality. Another alternative is to replenish the in-flight aerosol droplets with the volatile solvent via the sheath gas. Too low of a solvent content causes a dry ink with overspray (deposits outside the desired pattern), while too high of a solvent content in the droplets can lead to splattering of the droplet, which can distort the trace edge resolution and width. Accordingly, those knowledgeable in the art adjust the solvent content based on printing performance.

Aerosol Flowrate—

The speed at which the refractory metal ink strikes the surface in part governs the fluid dynamics of how the ink droplets adhere, including shape, coalescing, splashing, etc. This is governed with a mass flow controller (MFC). In certain embodiments, the ink droplets impact the substrate at about 50 m/s. In certain embodiments, the ink droplets impact the substrate at between about 20 m/s and about 80 m/s.

Sheath Gas Flowrate—

When the refractory metal ink is deposited by Aerosol Jet printing, the sheath gas velocity (also controlled with an MFC) relative to the ceramic nozzle diameter being used shapes the aerosol beam and determines printed line width. This substantially affects what is called overspray or ink deposits outside the targeted lines.

Nozzle Size—

The nozzle size also governs the print width along with the relative flow rates of sheath and atomizer flow. The printed line width can be anywhere from 0.07 to 0.5 times the diameter of the nozzle.

Platen Speed—

In certain embodiments, the systems and methods comprise a platen configured to support a substrate. In certain embodiments, the controller is operative to move the platen relative to the nozzle. The speed of the platen translation relative to the nozzle should be matched to the mass flow rate of ink to achieve the proper line quality, continuity and thickness. Failing to do so can result in lines with incomplete deposition or line bleeding. In certain embodiments, lateral platen speeds relative to the nozzle are between about 0.5 mm/s and about 25 mm/s.

Platen Temperature—

In certain embodiments, the platen further comprises a heating unit operative to apply heat to the substrate. The heating unit in the platen can be used to partially or completely cure the ink during printing and to control the bleed out of the ink droplets upon impact onto the substrate. In certain embodiments, the platen heater heats the platen to about 30° C. and about 60° C. Heating the platen and the substrate can contribute to rapid curing of the ink by driving off the solvent content left in the ink now adhered to the substrate.

Substrate Choice and Preparation—

The contact angle of the ink with the substrate will be governed by the surface tension of the ink with respect to the substrate. Presence of organic contaminants also impacts the contact angle and wettability of the ink onto the substrate. Cleaning practices such as isopropanol and acetone wash are employed to ensure a clean substrate surface. Plasma treating the substrate with an oxygen or hydrogen plasma provides uniform surface termination that promotes better wetting.

Printing strain gages or other conductive patterned articles directly on the components to be tested typically requires printing on a complex non-planar 3D surface. For ceramic/non-conducting components, metal strain gages can be printed directly on the article under test. For metallic components, either an insulating layer is printed underneath or the sensor is printed on a high temperature substrate and adhered to the component under test with high temperature cement.

Polyimide insulating layers are useful to 300° C. Polyimide film is a commonly used substrate because its surface energy (45-50 mN/m) is favorable for good wetting by most inks and it can be processed at fairly high temperatures. It is cleaned with an isopropanol wash and an oxygen plasma treatment for two minutes.

In certain embodiments, the substrate comprises an insulating ceramic. In certain embodiments, the insulating ceramic comprises a material selected from the group consisting of yttrium stabilized zirconia, commercial high temperature ceramic cement, an oxide material formed by metal-organic decomposition, and combinations thereof.

In certain embodiments, the refractory metal ink is deposited on a refractory insulating substrate selected from the group consisting of alumina, mullite, yttria-stabilized zirconia, thin flexible yttria-stabilized zirconia, silicon dioxide, glass, and thin flexible glass. Yttria stabilized zirconia (YSZ) substrates are stable to ≧1000° C. and mimic the likely undercoat used during deposition on a steel or other metal article. They are also commercially available in thin flexible form. They are prepared with an isopropanol wash and an oxygen plasma cleaning for two minutes.

In certain embodiments, the patterned article is deposited directly on the components to be tested. For ceramic or other non-conducting components, this is possible without an intermediate layer, but for metallic components, either an insulating layer will be printed underneath or the sensor will be printed on a high temperature insulating substrate and adhered to the component under test with high temperature cements or with exothermic reactive compounds by combustion joining. Commercially available thin flexible ceramic and glass substrates are a platform that allows planar printing and high temperature firing of the sensors before application to the 3D object to be tested. FIG. 14 shows a platinum test pattern with multiple layer configurations printed on such a thin flexible YSZ substrate.

Curing Conditions—

The methods of making a patterned article comprise curing the deposited refractory metal ink.

In certain embodiments, the ink is cured by heating at temperatures above ambient temperature in air. Thermal curing in air is the traditional method for ink curing the deposited refractory metal ink to remove the solvent and provide a patterned article. In certain embodiments, curing temperature ranges are 125-300° C. for complete curing. Low-temperature polymer substrates may only permit lower temperature curing, depending on their softening temperature and incomplete curing may have to be used as a result unless other methods such as photonic curing are available.

In certain embodiments, the ink is cured by heating at temperatures above ambient temperature in a neutral or reducing atmosphere. In certain embodiments, the neutral or reducing atmosphere comprises nitrogen, helium, neon, argon, hydrogen, ammonia, forming gas (approximately 95% N2 and 5% H2) or wherein the ambient atmosphere is a vacuum. A reducing atmosphere is an important tool to prevent oxidation of some species, such as nickel and copper.

In certain embodiments, the ink is cured through application of a laser beam. Laser curing is rapid so as to prevent oxidation.

In certain embodiments, the ink is photonically cured through application of high intensity light. High intensity light cures inks rapidly without the risk of processes such as oxidation that take time for transport. For good curing of a silver nanoparticle ink, a xenon lamp may be pulsed at a power of 1000-1500 V for 0.5-2 ms. Inks and additives can specifically be tuned to benefit from the features of photonic curing.

Inks are cured to remove solvents and other organics, bind the ink to the substrate and sinter metal particles together. Curing conditions of the ink should ensure that the patterned article remains stable over the range of the operating temperature. The curing atmosphere is of concern as the processing conditions depend on whether and how the components of the refractory metal ink react and at what temperature. Pt—Au inks will not oxidize in air at any temperature. Thermodynamically there is not be enough free energy to demix Rh from Pt and form the oxide, but Ni and W inks require a reducing atmosphere. In instances where the refractory metal ink is deposited by Aerosol Jet printing, a potential first step is to pass the carrier gas in the AJ deposition system through a catalytic converter to make it oxygen-free. Once the ink is deposited, it is stable against oxidation until heated. To cure the ink, place the article in an air-tight chamber in a furnace or over a hotplate. Flush the chamber with forming gas (nominal 95% N2, 5% H2), which is reducing but not flammable. Heat to 210° C. or higher, which is the nominal ink curing temperature, and hold for 75 minutes. Heat at 1° per minute to 500° C. and hold for 12 hours to sinter the ink more completely. Cool to room temperature.

Systems for Depositing Refractory Metal Inks

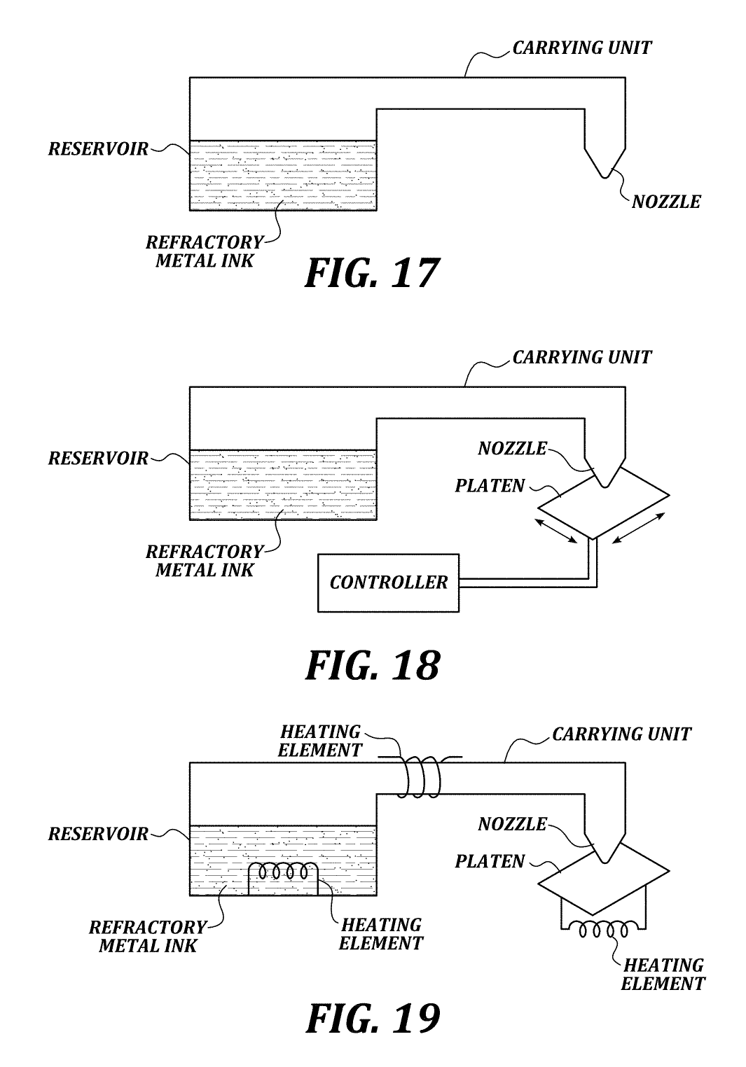

In another aspect, the present application provides a system for depositing refractory metal inks of the present application. In certain embodiments, the system comprises a reservoir comprising a refractory metal ink as disclosed herein; and a carrying unit operative to carry the refractory metal ink to a nozzle. Such a system is depicted in FIG. 17. With reference to FIG. 17, the reservoir holds the refractory metal ink is adjacent to a carrying unit configured to carry the refractory metal ink to the nozzle.

The reservoir is configured to hold the refractory metal ink and release it to the carrying unit.

In certain embodiments, the system comprises one or more heating elements. In certain embodiments, the reservoir comprises a heating unit operative to heat the refractory metal ink. As described above, heating in the reservoir influences how the refractory metal ink aerosolizes with higher temperatures sometimes aiding in aerosolization. In certain embodiments, the carrying unit comprises a heating unit. Such a heating unit is useful in evaporating solvent from aerosolized refractory metal ink. In certain embodiments, the platen comprises a heating unit operative to apply heat to the substrate. Such heating units are useful to cure deposited refractory metal inks. FIG. 19 depicts a system, wherein the reservoir comprises a heating unit configured to heat the refractory metal ink, the carrying unit comprises a heating unit configured to heat the carrier gas and atomized refractory metal ink, and the platen comprises a heating unit configured to heat the platen and any substrate.

In certain embodiments, the systems further comprise an atomization unit operative to atomize the refractory metal ink. In certain embodiments, the atomization unit is selected from an ultrasonic atomization unit and a pneumatic atomization unit. Pneumatic atomization unit can atomize higher viscosity inks (50-1000 cP), and ultrasonic atomization units can be used with much smaller quantities for very expensive inks if the viscosity is low enough (1-10 cP).

In certain embodiments, the systems further comprise a platen configured to support a substrate. The platen is further configured to dispose the substrate relative to the nozzle to receive the refractory metal ink.

The systems disclosed herein comprise a nozzle. In certain embodiments, the nozzle is configured to deposit the refractory metal onto the substrate. In certain embodiments, the nozzle has an annular inner diameter between about 100 and 300 microns. The nozzle size also governs the print width along with the relative flow rates of sheath and atomizer flow. The printed line width can be anywhere from 0.07 to 0.5 times the diameter of the nozzle.

In certain embodiments, the system comprises a carrier gas in fluidic communication with the refractory metal ink. In certain embodiments, the carrier gas is configured to carry the ink from the reservoir to the substrate.

The carrier gas can be any gas configured to carry droplets of the refractory metal inks disclosed herein. In certain embodiments, the carrier gas is an inert gas. Such carrier gases may be preferred because they will not oxidize or otherwise react with the refractory metal ink. In certain embodiments, the carrier gas is selected from the group consisting of air, nitrogen gas, helium gas, neon gas, argon gas, hydrogen gas, forming gas (approximately 95% N₂ and approximately 5% H₂). In certain embodiments, the carrier gas further comprises a solvent of the refractory metal ink. Such additional solvent in the carrier gas is useful in getting the refractory metal ink from the reservoir into the carrier gas in the carry unit.

In certain embodiments, the carrying unit comprises a coaxial tube comprising a first tube disposed within a lumen of a second tube, wherein the first tube is in fluidic communication with the refractory metal ink and a carrier gas and the second tube is in fluidic communication with a sheath gas.

In certain embodiments, the system further comprises a controller operative to control various components of the system. FIG. 6 depicts a system controller operatively connected to and configured to control the carrier gas, the sheath gas, the atomization unit, and the platen. As depicted in FIG. 6, the atomization unit atomizes the refractory metal ink into a mist. The mist is carried by the carrier gas from the portion of the reservoir over the refractory metal ink into the carrying unit. From the carrying unit the carrier gas and aerosolized refractory metal ink move into the nozzle, where the sheath gas focusses the carrier gas stream before the refractory metal ink is deposited into the substrate in the form of a deposited article.

In certain embodiments, the controller is operative to modulate the carrier gas flow rate and the sheath gas flow rate. In certain embodiments, the controller is operative to modulate the relative flow rates of the carrier gas and the sheath gas.

In certain embodiments, the controller is operative to move the platen relative to the nozzle. FIG. 18 depicts a system comprising a controller operatively connected to the platen and configured to move the platen relative to the nozzle. In certain embodiments, the platen moves at between about 0.5 mm/s and about 25 mm/s. In certain embodiments, the platen moves at between about 1 mm/s and about 5 mm/s. In certain embodiments, the platen moves at between about 4 mm/s and about 9 mm/s. In certain embodiments, the platen moves at between about 5 mm/s and about 8 mm/s.

In certain embodiments, the controller further comprises: a processor; data storage, having stored therein computer-readable program instructions that, upon execution by the processor, cause the controller to perform functions comprising: depositing the refractory metal ink on a substrate in a pattern; and curing the deposited refractory metal ink to provide a patterned article. A computer-aided design (CAD) pattern is input into the AJ system computer to define the toolpath.

In certain embodiments, the toolpath is a serpentine pattern in the shape of a strain gage. In certain embodiments, the toolpath is a serpentine pattern comprising a zig-zag pattern of roughly parallel lines.

In certain embodiments, the computer readable program instructions comprise instructions that, upon execution by the processor, cause the controller to iteratively deposit refractory metal ink on the same portion of the substrate. Doing so can achieve a desired or increased thickness in the ultimate patterned article.

In certain embodiments, the computer readable program instructions comprise instructions that, upon execution by the processor, cause the controller to deposit a refractory metal ink disclosed herein on a substrate in a pattern. The pattern can be any pattern. In certain embodiments, the refractory metal ink is deposited at least partially in the form of a line. In certain embodiments, the line has a maximum thickness of about 150 micron. In certain embodiments, the line has a maximum thickness of about 120 micron. In certain embodiments, the line has a maximum thickness of about 100 micron. In certain embodiments, the line has a maximum thickness of about 90 micron. In certain embodiments, the line has a maximum thickness of about 80 micron. In certain embodiments, the line has a maximum thickness of about 70 micron. In certain embodiments, the line has a maximum thickness of about 60 micron. In certain embodiments, the line has a maximum thickness of about 50 micron. In certain embodiments, the line has a maximum thickness of about 40 micron. In certain embodiments, the line has a maximum thickness of about 30 micron. In certain embodiments, the line has a maximum thickness of about 20 micron. In certain embodiments, the line has a maximum thickness of about 10 micron.

In certain embodiments, the pattern is in the form of a strain gage. In certain embodiments, the pattern comprises a zig-zag or serpentine pattern of roughly parallel lines. In certain embodiments, the pattern is in the form of a thermocouple.

Articles

In another aspect, the present application provides an article at least partially deposited from a refractory metal ink. The refractory metal ink can be a refractory metal ink disclosed herein. In certain embodiments, the article comprises a metal alloy. In certain embodiments, the article comprises an inclusion of a solid non-metal particle. In certain embodiments, the article is hardened against high-temperature grain boundary motion. Such articles comprise inhomogeneities at or near grain boundaries. Previous printed articles did not have such inhomogeneities. These inhomogeneities prevent or limit grain boundary motion.

NDE, SHM and PMC tools and services to the aerospace and petrochemical industries are well established but limited in temperature operation. High temperature sensors capable of operation to 1000° C., such as those disclosed herein, enable many new devices.

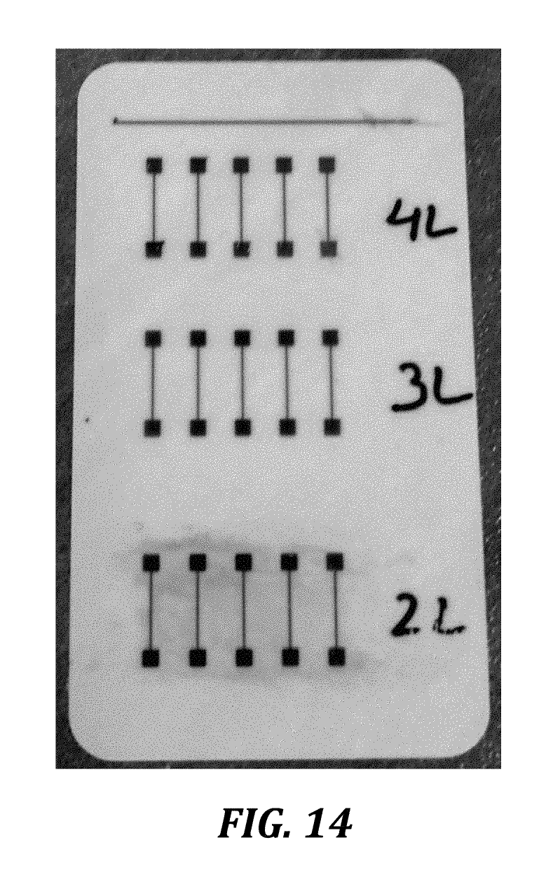

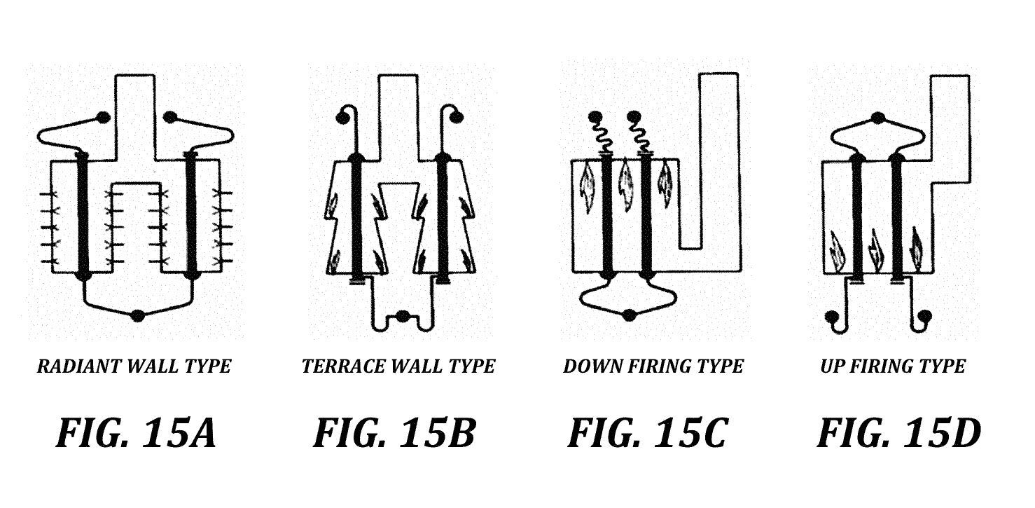

Reformer tubes are high temperature stainless steel tubes with an operating range to 800-871° C. and 5-8 MPa. There is no current method for structural health monitoring at such high operating temperatures. Smaller nickel-iron-chromium Incoloy alloy tubes are used to transfer syngas (synthesis fuel gas precursor mixture for synthetic natural gas) from the reformer to the manifold. They are called pigtails because of the convoluted geometries required to accommodate thermal expansion (FIG. 15). The pigtails are particularly at risk for deformation and failure from creep rupture, creep fatigue at terminal welds, creep fatigue cracking at bends, overheating and environmental attack, e.g., nitriding. They are impossible to inspect by in-line inspection because of their small diameter. Creep damage and bulging is the main risk factor and a 3% increase in diameter indicates increased risk and a need for detailed investigation by dye penetrant or radiography. There is a strong industry need for SHM of reformer tubes and pigtails that the methods, refractory metal inks, and systems can uniquely address.

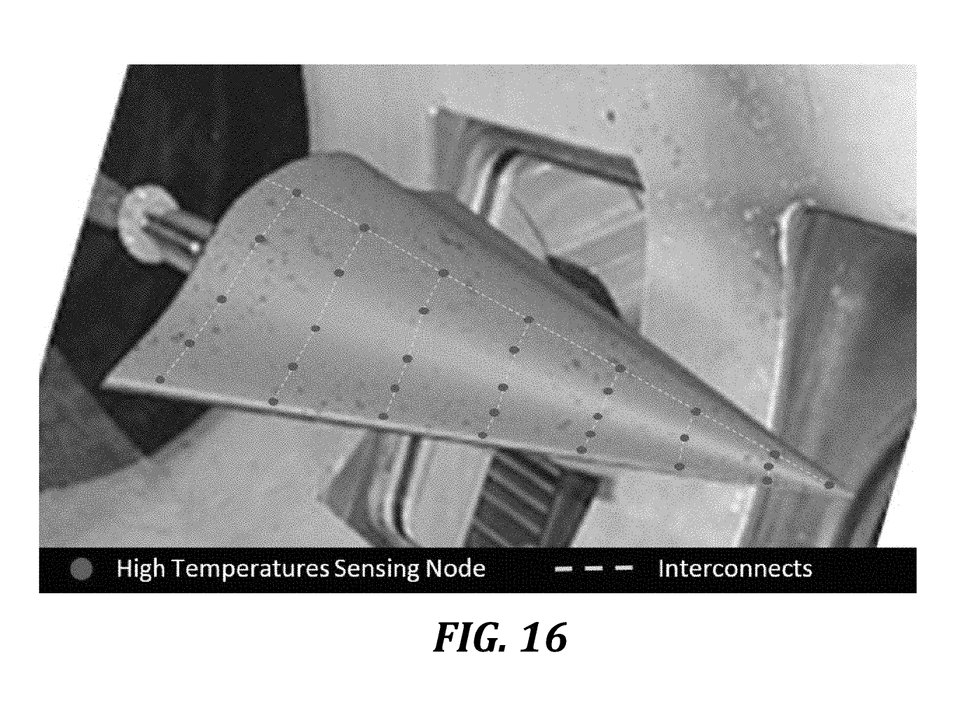

The successful development of high temperature sensors opens new ways to monitor and control thermal and structural loads and processes in high temperature environments. These situations are critical for the performance of propulsion systems as well as hypersonic and space vehicles (FIG. 16). The high temperature sensors of the present technology allow the placement of sensors on difficult-to-access areas, on surfaces with single or double curvature, and on places where current technologies are too bulky, such as thin blades or thin parts. In certain embodiments, the article comprises a plurality of temperature sensors and strain gages coupled together by interconnects, as depicted in FIG. 16. With reference to FIG. 16, the plurality of temperature sensors and plurality of strain gages are deposited onto the three-dimensional surface of a model aircraft wing. The plurality of temperature sensors and plurality of strain gages are electrically connected by a plurality of interconnects disposed between and in conductive communication with the temperature sensors and strain gages.

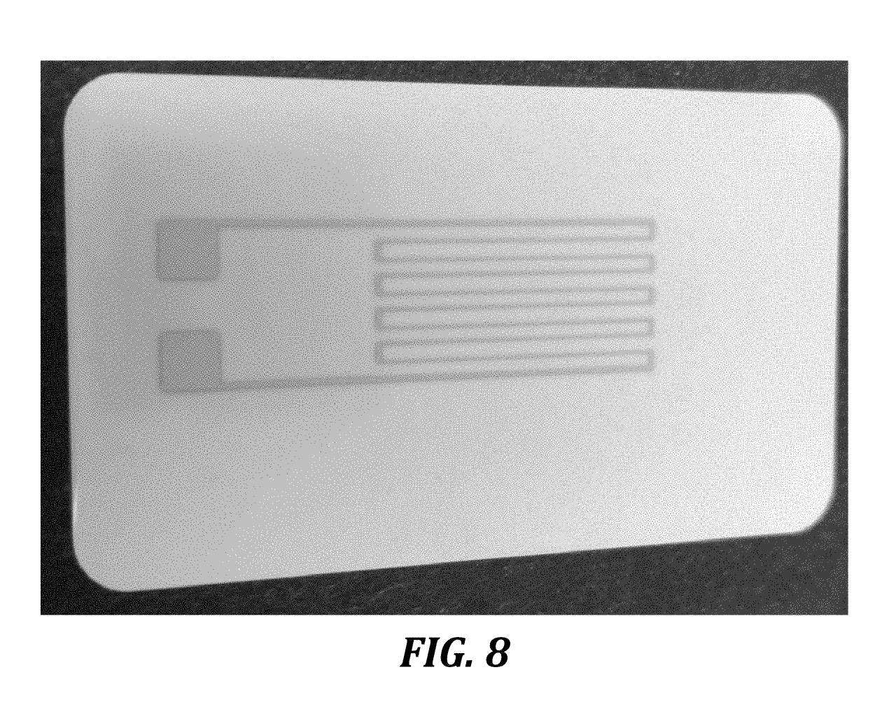

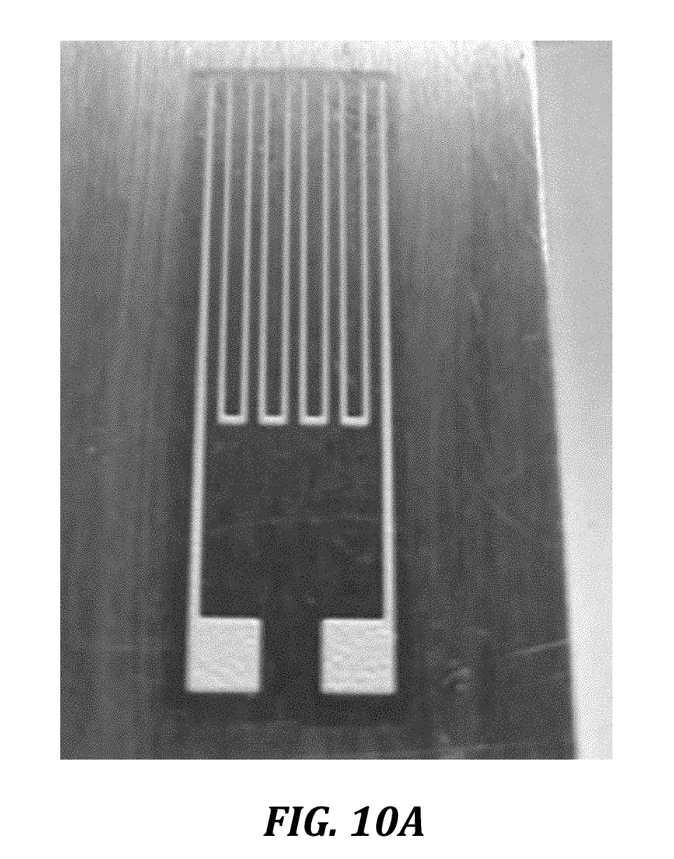

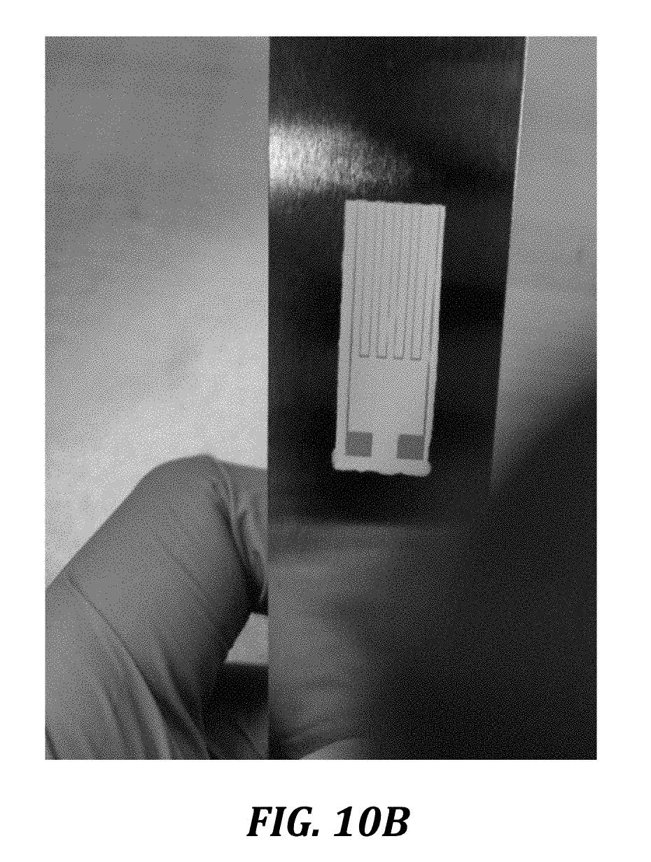

In certain embodiments, the article is a strain gage. Examples of such strain gages are depicted in, for example, FIGS. 8, 10(a), and 10(b). In certain embodiments, the article has a serpentine pattern comprising a zig-zag pattern of roughly parallel lines.

In certain embodiments, the article comprises a material selected from the group consisting of a metal alloy, an inclusion of a solid non-metal particle, and combinations thereof, and wherein the article is hardened against high-temperature grain boundary motion deposited at least partially in the form of a line. In certain embodiments, the line has a maximum thickness of about 150 micron. In certain embodiments, the line has a maximum thickness of about 120 micron. In certain embodiments, the line has a maximum thickness of about 100 micron. In certain embodiments, the line has a maximum thickness of about 90 micron. In certain embodiments, the line has a maximum thickness of about 80 micron. In certain embodiments, the line has a maximum thickness of about 70 micron. In certain embodiments, the line has a maximum thickness of about 60 micron. In certain embodiments, the line has a maximum thickness of about 50 micron. In certain embodiments, the line has a maximum thickness of about 40 micron. In certain embodiments, the line has a maximum thickness of about 30 micron. In certain embodiments, the line has a maximum thickness of about 20 micron. In certain embodiments, the line has a maximum thickness of about 10 micron.

In certain embodiments, the article comprises a material selected from the group consisting of a metal alloy, an inclusion of a solid non-metal particle, and combinations thereof, and has a melting temperature of between about 600° C. and about 1,500° C. In certain embodiments, the article has a melting temperature of between about 700° C. and about 1,800° C. In certain embodiments, the article has a melting temperature of between about 800° C. and about 1,500° C. In certain embodiments, the article has a melting temperature of between about 900° C. and about 1,200° C.

In certain embodiments, the article has a thickness between about 1 micron and 30 microns. In certain embodiments, the article has a thickness between about 1 micron and about 5 microns.

In certain embodiments, the article is a thermocouple. Accurate strain gage readout at high and varying temperatures also requires temperature sensing for calibration, which may be accomplished by a thermocouple or resistance temperature device.

In certain embodiments, the thermocouple comprises a material selected from the group consisting of: Pt—Au, Pt—Pt₁₀₀₋ₓRhₓ, Pt₁₀₀₋ₓRhₓ—Pt_{100-y}Rh_{y}, Ag—Ni, and combinations thereof, wherein x is a number between about 10 and about 30, and y is a number between about 0 and about 6.

In certain embodiments, the article is an electrical connector. In certain further embodiments, the electrical connector is selected from the group consisting of an interconnect, an antenna, a communication line, a power connector, an interdigitated electrode, a capacitor, an inductor, a resistance temperature detector, and an environmental sensor.

Furthermore, as a result of their light weight, the printed high temperature sensors can be deposited on multiple points, creating sensing arrays to monitor large areas without imposing a significant weight penalty on the system.

Other applications for the technology include the following:
Rotor and stator blades on turbine engines for aircraft propulsion,
Fuel consumption optimization and combustion chamber process monitoring and control,
Thermal management of nozzles on rocket engines,
Thermal and structural monitoring systems on hypersonic structures and vehicles,
Thermal and structural assessment systems for aerodynamic models during hypersonic wind tunnel testing,
Reactor components,
Thermal management of thermal protection systems for spacecraft reentry structures,
Structural monitoring systems for spacecraft reentry phase,
Thermal management systems for space structures,
Thermal blankets,
Pressure vessels, particularly high temperature pressure vessels,
Integration of sensing elements with or within 3D printed ceramic structural components, and
Structural health monitoring of reusable spacecraft system during its whole flight envelope. Data gathered during flight will provide a more accurate life assessment of the spacecraft structural integrity reducing risk as well as redeployment time.
Tracking parameters such as temperature, strain, and pressure to assess the performance of a system or process and use the information to modify it.

The articles disclosed can be formed according to any of the methods disclosed herein. In certain embodiments, the article is formed by depositing the refractory metal ink on a substrate using additive manufacturing methods selected from the group consisting of aerosol jet printing, inkjet printing, micro-syringe dispense printing, screen printing, roll-to-roll printing, and combinations thereof.

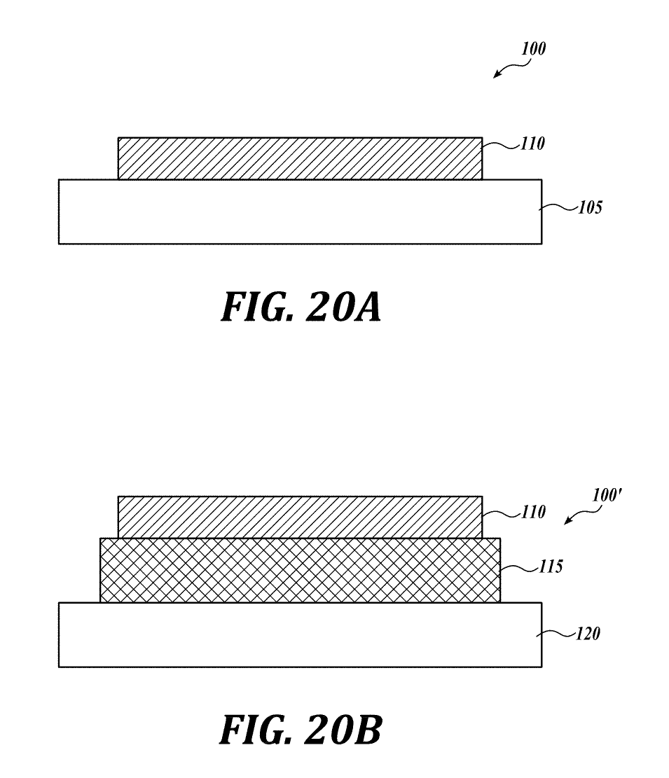

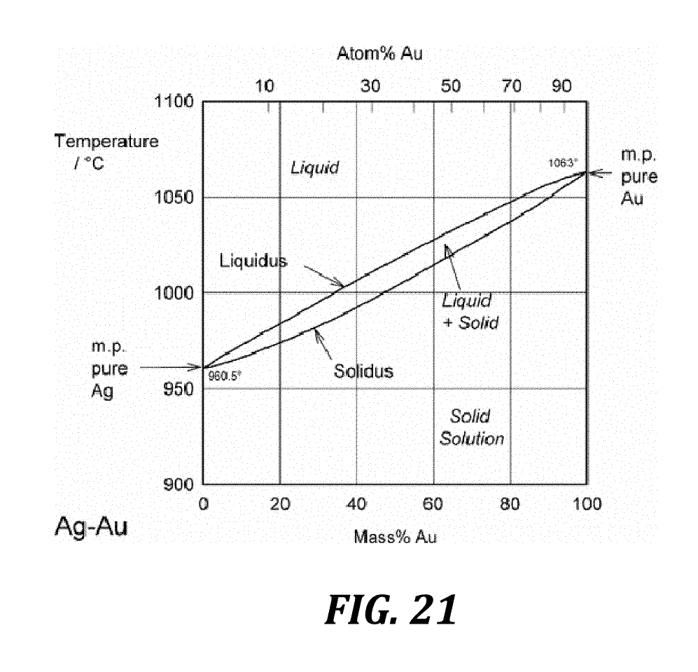

In certain embodiments, the article is deposited onto a substrate. In certain embodiments the article is deposited directly onto a substrate. Such embodiments include when an article is deposited on a non-conductive substrate. FIG. 20A depicts an article 110 deposited directly onto a non-conductive substrate 105. In certain embodiments wherein the substrate is conductive and the article is also conductive, such as in the case of a strain gage applied to a metal airplane wing, the article is deposited on an insulating material, which is adhered to the substrate. Such an embodiment is depicted in FIG. 20B, wherein article 110 is deposited on insulating substrate 115, which is adhered to conductive substrate 120.

In certain embodiments, the insulating material comprises a material selected from the group consisting of yttrium stabilized zirconia, commercial high temperature ceramic cement, an oxide material formed by metalorganic decomposition, and combinations thereof. In certain embodiments, the refractory metal ink is deposited on a refractory insulating substrate selected from the group consisting of alumina, mullite, yttria-stabilized zirconia, thin flexible yttria-stabilized zirconia, silicon dioxide, glass, and thin flexible glass.

In certain embodiments, the article is adhered to a refractory insulating or ceramic article.

In certain embodiments, the article comprises an insulating material applied under the conductor, applied over the conductor, or both.

The following examples are included for the purpose of illustrating, not limiting, the described embodiments.

### EXAMPLES

### Example 1

### Comparative Example—Pure Platinum Ink

A pure platinum nanoparticle ink can be made by co-reaction according to Y. Didenko and Y. Ni, U.S. Pat. No. 8,211,205 B1, Jul. 3, 2012. Form a mixture by stirring 0.2 mole % platinum chloride (PtCl₂), 2 mole % oleylamine and 97.8 mole % toluene together in a reaction vessel under an argon atmosphere for one hour until the chloride is dissolved completely. The metal is now dissolved as amine complexes. In a separate vessel mix 0.1 mole % sodium borohydride (NaBH₄) into 99.9 mole % anhydrous ethanol for one hour until the sodium borohydride is dissolved completely. Titrate by volume 2× of the sodium borohydride solution into 1× of the amine solution over a period of 30 minutes until the nanoparticle precipitation ends. Centrifuge the resulting colloid to segregate the nanoparticles and decant the solvent. Add back toluene to achieve 20% solids loading by volume for the ink and add 2% by weight sodium n-dodecyl sulfate as a dispersant.

### Example 2

### Representative Example—Alloy Nanoparticle Refractory Metal Ink

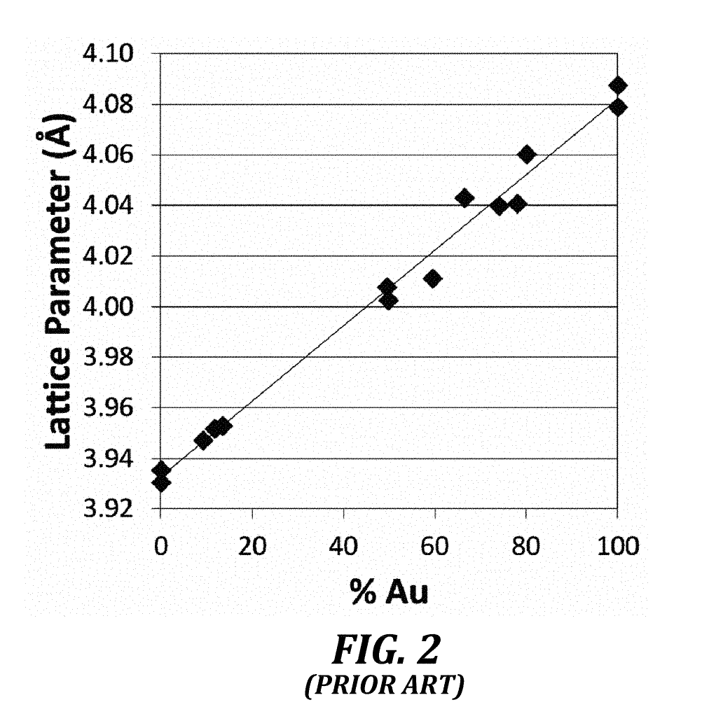

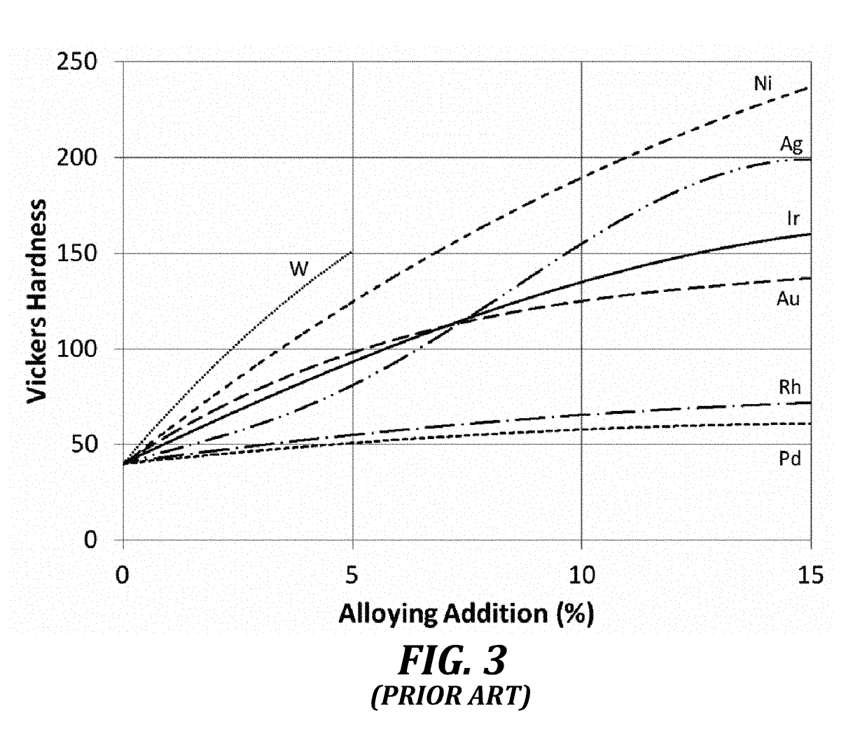

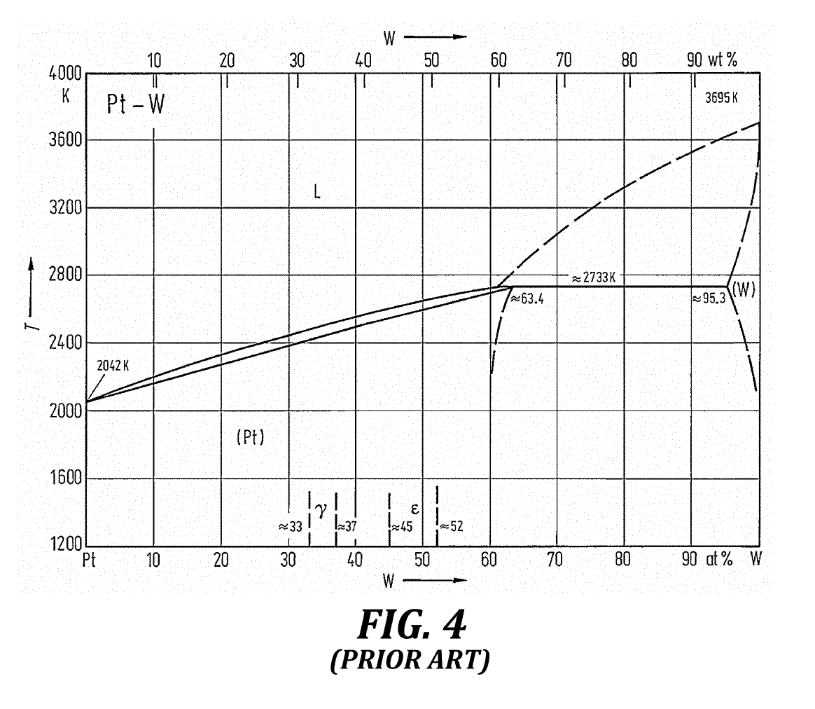

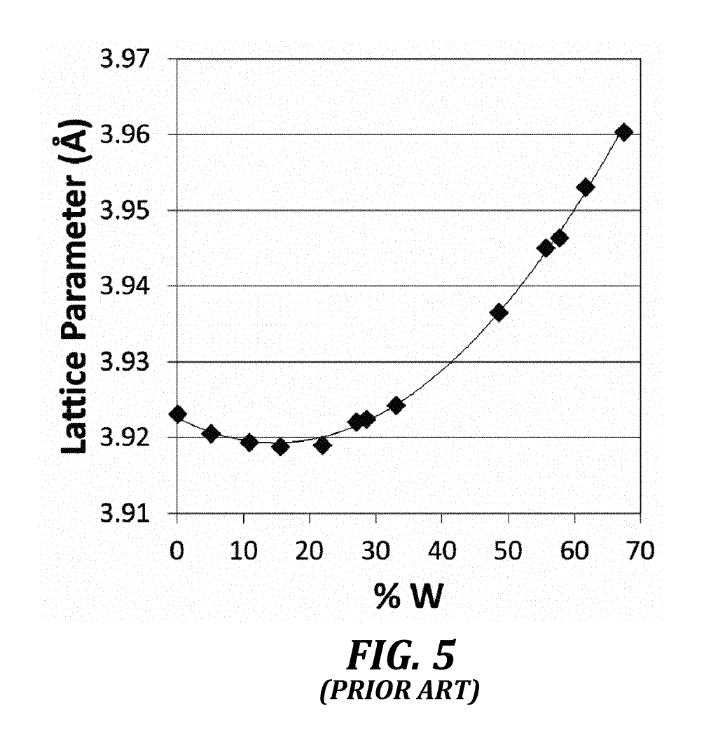

A Pt—Au nanoparticle ink of nominal composition Pt-88%:Au-12% may be made by mixing of individual Pt and Au nanoparticle inks with the same solvent system in the desired alloy proportions. Inks are mixed ultrasonically for 30 minutes for initial blending, stirred overnight in a magnetic stirrer and then mixed ultrasonically for an additional 30 minutes. The inks are stirred continuously while not being used and once again sonicated just before use. Pt—Au inks will not oxidize in air at any temperature. For curing after deposition, heat to 210° C., which is the nominal ink curing temperature, and hold for 75 minutes. Cool to room temperature. X-ray diffraction proves that this is fully reacted to a solid solution with a lattice parameter consistent with FIG. 2.

### Example 3

### Representative Example—Alloy Nanoparticle Refractory Metal Ink

A Pt88%:W12% alloy nanoparticle ink may be made by co-reaction. Form a mixture by stirring together 0.176 mole % platinum chloride (PtCl₂), 0.024 mole % tungsten hexachloride (WCl₆), 2 mole % oleylamine and 97.8 mole % toluene in a reaction vessel under an argon atmosphere for one hour until the chlorides are dissolved completely. The metals will now be dissolved as amine complexes. In a separate vessel mix 0.1 mole % sodium borohydride (NaBH₄) into 99.9 mole % anhydrous ethanol for one hour until the sodium borohydride is dissolved completely. Titrate by volume 2× of the sodium borohydride solution into 1× of the amine solution over a period of 30 minutes until the nanoparticle precipitation ends. Centrifuge the resulting colloid to segregate the nanoparticles and decant the solvent. Add back toluene to achieve 20% solids loading by volume for the ink and add 2% by weight sodium n-dodecyl sulfate as a dispersant.

### Example 4

### Representative Example—Alloy Nanoparticle Refractory Metal Ink

A Pt92%:Ni8% alloy nanoparticle ink may be made by co-reaction. Form a mixture by stirring together 0.184 mole % platinum chloride (PtCl₂), 0.016 mole % nickel (II) chloride (NiCl₂), 2 mole % oleylamine and 97.8 mole % toluene in a reaction vessel under an argon atmosphere for one hour until the chlorides are dissolved completely. The metals will now be dissolved as amine complexes. In a separate vessel mix 0.1 mole % sodium borohydride (NaBH₄) into 99.9 mole % anhydrous ethanol for one hour until the sodium borohydride is dissolved completely. Titrate by volume 2× of the sodium borohydride solution into 1× of the amine solution over a period of 30 minutes until the nanoparticle precipitation ends. Centrifuge the resulting colloid to segregate the nanoparticles and decant the solvent. Add back toluene to achieve 20% solids loading by volume for the ink and add 2% by weight sodium n-dodecyl sulfate as a dispersant.

The resulting inks were proven to be hardened against grain boundary motion and recrystallization.

### Example 5

### Representative Example—Depositing Refractory Metal Inks on a Substrate

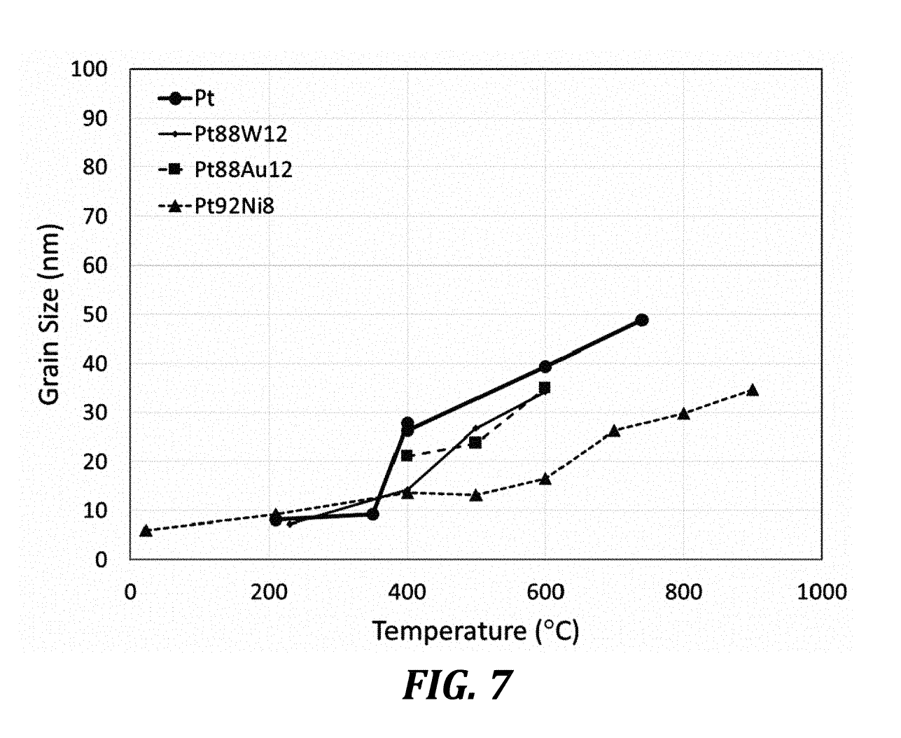

Inks of Examples 1-4 were swab printed on a fused silica substrate and annealed up to 600-900° C. X-ray diffraction (XRD) line widths and the Scherrer formula were used to determine the grain size. The results are shown in FIG. 7. All the additives improved the recrystallization behavior of the deposited ink, but the best performing alloying element with platinum was Ni, even though it had the lowest concentration. W and Au had similar, but lesser effects. The Pt—Ni composition is especially suitable for high temperature applications. The x-ray diffraction pattern of Pt92%:Ni8% annealed at 800° C. still has very broad peaks with no separation between the Kα1 and Kα2 peaks indicating that grain growth is substantially inhibited.

### Example 6

### Representative Example—Methods of Making Alloy Nanoparticles by Spark Discharge Generation

A Pt90%:Rh10% alloy nanoparticle ink can be made by spark discharge generation. Pt—Rh nanoparticles are formed by spark discharge generation using 2 mm commercial Pt90%-Rh10% thermocouple wire as starting material. A high voltage power supply is used to charge a capacitor connected in parallel to a spark gap between two Pt—Rh electrodes in an argon atmosphere flowing at 2.5 standard liters per minute. When the capacitor reaches breakdown voltage of the gas in the spark gap, a discharge occurs, causing evaporation of a small amount of the Pt—Rh electrode material. This condenses to form nanoparticles <10 nm in size, which are carried away by the gas flow and collected on a membrane filter. The repetition rate is 300 Hz. The collected nanoparticles are rinsed from the filter with ethanol to form an ink with 20% solids loading. 2% by weight sodium n-dodecyl sulfate is added as a dispersant.

### Comparative Example 7

### Comparative Example—Making and Screen Printing Pure Platinum Microparticles

Obtain pure platinum microparticles approximately 1 μm in average diameter by purchase or manufacture. Mix together 12 wt % polyvinyl pyrrolidone (PVP), 69.5 wt % distilled water, 12 wt % ethylene glycol (lower vapor pressure component), 6 wt % isopropanol (higher vapor pressure component) and 0.5% by weight of commercial polar dispersant such as DISPERBYK 111 (BYK Additives and Instruments, Geretsried, Germany). Mix an ink using 85 wt % platinum microparticles and 15 wt % ink vehicle. Homogenize in an ultrasonic bath for 30 minutes, mix for 30 minutes in a planetary mixer, stir overnight in a magnetic stirrer and then further homogenize in a planetary mixer for another 30 minutes and in an ultrasonic bath for 30 minutes. Stir the ink continuously in a magnetic stirrer until it is used to prevent precipitation, separation, or agglomeration. Alternatively obtain a commercial thick film platinum paste. Screen print this ink to a desired pattern such as a serpentine strain gage on a ceramic substrate using a screen with 325 mesh. The final deposited thickness should be 20 microns. Dry at 200° C. for 1 hour to remove the solvent. Pyrolyze at 500° C. for 1 hour to remove any remaining organic material. Sinter the resulting microparticle article at 950° C. for 12 hours in air to form a solid article. Such an article is shown in FIG. 8.

### Example 8

### Representative Example—Methods of Making and Printing Alloy Refractory Metal Microparticles

Manufacture Pt95%-Ni8% microparticles approximately 1 μm in average diameter by milling pieces of commercial Pt95%-Ni8% wire. Mix together 12 wt % polyvinyl pyrrolidone (PVP), 69.5 wt % distilled water, 12 wt % ethylene glycol (lower vapor pressure component), 6 wt % isopropanol (higher vapor pressure component) and 0.5% by weight of commercial polar dispersant such as DISPERBYK 111 (BYK Additives and Instruments, Geretsried, Germany). Mix an ink using 85 wt % Pt95%-Ni8% microparticles and 15 wt % ink vehicle. Homogenize in an ultrasonic bath for 30 minutes, mix for 30 minutes in a planetary mixer, stir overnight in a magnetic stirrer and then further homogenize in a planetary mixer for another 30 minutes and in an ultrasonic bath for 30 minutes. Stir the ink continuously in a magnetic stirrer until it is used to prevent precipitation, separation, or agglomeration. Screen print this ink to a desired pattern such as a serpentine strain gage on a ceramic substrate using a screen with 325 mesh. The final deposited thickness should be 20 microns. Dry at 200° C. for 1 hour to remove the solvent. Pyrolyze at 500° C. for 1 hour to remove any remaining organic material. Sinter the resulting microparticle article at 950° C. for 12 hours in air to form a solid article.

### Example 9

### Representative Example—Silver Nanoparticle Ink Comprising Diamantine Non-Metal Particles

Silver-diamantane ink. Mix 0.1% by weight diamantane (C₁₄H₂₀ CAS#2292-79-7) nanoparticles into a silver nanoparticle ink. Homogenize in an ultrasonic bath for 30 minutes, stir overnight in a magnetic stirrer and then further blend ultrasonically for another 30 minutes. Stir the ink continuously in a magnetic stirrer until it is used to prevent segregation, separation, or agglomeration and then homogenize ultrasonically for 30 minutes immediately before use.

### Example 10

### Representative Example—Silver-Yttria Stabilized Zirconia Ink

To a custom or commercial silver nanoparticle ink, add 1% by weight yttria-stabilized zirconia (YSZ) nanoparticles (average diameter 5-10 nm) and 0.1% by weight DISPERBYK 111 polar dispersant (BYK Additives and Instruments, Geretsried, Germany). Homogenize in an ultrasonic bath for 30 minutes, mix for 30 minutes in a planetary mixer, stir overnight in a magnetic stirrer and then further homogenize in a planetary mixer for another 30 minutes and in an ultrasonic bath for 30 minutes. Stir the ink continuously in a magnetic stirrer until it is used to prevent precipitation, separation, or agglomeration and then homogenize ultrasonically for 30 minutes immediately before use.

### Example 11

### Representative Example—Depositing Refractory Metal Inks Comprising Metal Nanoparticles and Non-Metal Particles

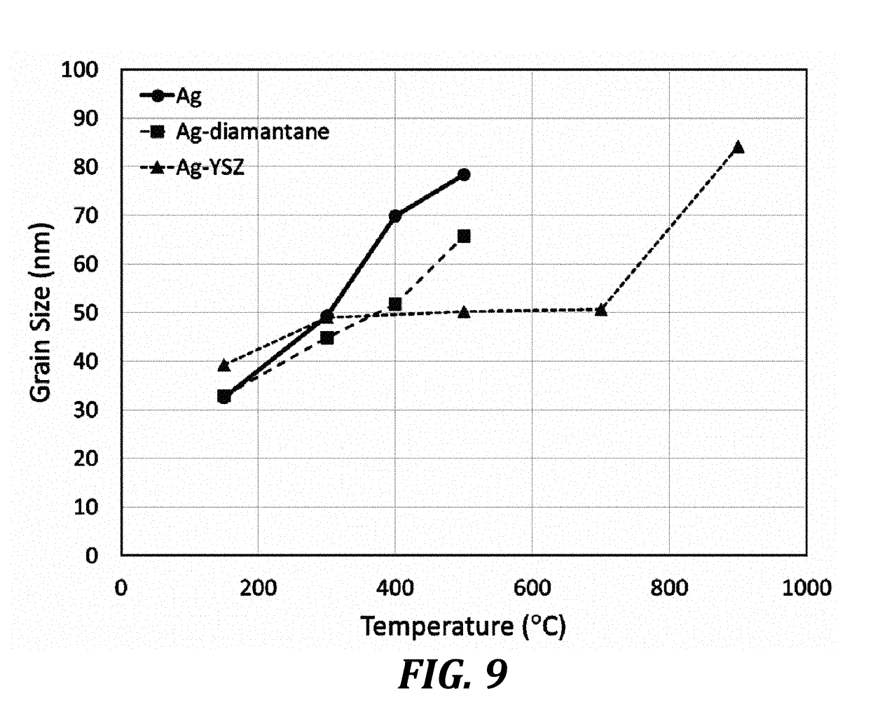

Inks of Examples 9 and 10 as well as the base silver ink with no particulate additive were swab printed on a fused silica substrate and annealed up to 500-900° C. X-ray diffraction line widths and the Scherrer formula were used to determine the grain size. The results are shown in FIG. 9. Diamantane particles slightly impeded crystallization, but only slowed it, most likely because of the low concentration necessitated by low density, small size and high cost. Following slight average grain size increase during the initial curing and consolidation of the ink up to 300° C., YSZ nanoparticles arrested recrystallization up to >740° C. This level of performance to at least 740° C. exceeded expectations as the melting temperature of silver is 961° C.

### Example 12

### Representative Example—Refractory Metal Ink Comprising Nickel Nanoparticles and Graphite Non-Metal Particles

Mix together 12 wt % polyvinyl pyrrolidone (PVP), 69.5 wt % distilled water, 12 wt % ethylene glycol (lower vapor pressure component), 6 wt % isopropanol (higher vapor pressure component) and 0.5% by weight of commercial polar dispersant such as DISPERBYK 111 (BYK Additives and Instruments, Geretsried, Germany). Mix an ink using 80 wt % Ni microparticles, 5% graphite microparticles and 15 wt % ink vehicle. Homogenize in an ultrasonic bath for 30 minutes, mix for 30 minutes in a planetary mixer, stir overnight in a magnetic stirrer and then further homogenize in a planetary mixer for another 30 minutes and in an ultrasonic bath for 30 minutes. Stir the ink continuously in a magnetic stirrer until it is used to prevent precipitation, separation, or agglomeration. Screen print this ink to a desired pattern such as a thermocouple arm on a polyimide substrate using a screen with 325 mesh. The final deposited thickness should be 20 microns. Dry at 125° C. for 1 hour to remove the solvent. Cure in a pulsed photonic curing system such as a Novacentrix Pulse Forge. The combination of the reducing graphite particles and the high speed pulsed curing prevent the nickel particles from oxidizing and enable curing to a high conductivity article. Even in the absence of graphite, the PVP forms an ash acting as source of carbon for reduction and inclusions, though at sufficiently high temperature this ash will be completely oxidized and vaporized.

### Example 13

### Representative Example—Aerosol Jet Printing of Strain Gages from a Pt90%:Ni10% Alloy Ink on Substrates of Polyimide and Yttria-Stabilized Zirconia

In this case the viscosity of the ink is sufficiently low that the ultrasonic atomizer fo the aerosol jet system is used. A solvent addition of 10 volume % alpha terpineol is made followed by sonication for 10-15 minutes just before the ink is used. The temperature of the in-line tube heater is set to 28-32° C. for this ink. For this ink, the sheath gas MFC is set to 30-50 ccm. For this ink, the ultrasonic atomizer MFC is set to 12-16 ccm (cubic centimeters per minute). In this case, a 200 micron diameter nozzle was used and a line width of 50-70 microns was achieved. For this ink and pattern, 1-5 mm/sec translation speed is used. In this case, it is desired that the ink spread slight rather than cure instantly so no platen heating is used.

A computer-aided design (CAD) pattern is input into the AJ system computer to define the toolpath. The strain gage is formed from a 50 turn serpentine pattern with 25 mm long, 50-70 μm wide traces spaced 200 μm apart for an overall pattern 13×25 mm in size. The end pads for making contact are 3 mm solid fill. The pattern is iterated 4-5 times to achieve the desired thickness of approximately 5 microns.

### Example 14

### Representative Example—Screen Printing of a Silver-YSZ Composite Ink to Form a Strain Gage

Screen printing of a silver-YSZ composite ink to form a strain gage can be done on metal substrates if electrically insulated by an insulating material such as polyimide, which can operate to moderately high temperatures or yttria stabilized zirconia. In FIG. 10A a 5000 cP viscosity polyimide ink has been screen printed in a rectangular pattern using three layers and three layers of the silver-YSZ ink of Example 10 have been screen pattern printed on top with a screen with a 325 mesh. Two layers of YSZ ink (see Example 15 below) were printed as the insulating layer in FIG. 10B. These patterns were cured at 300° C.

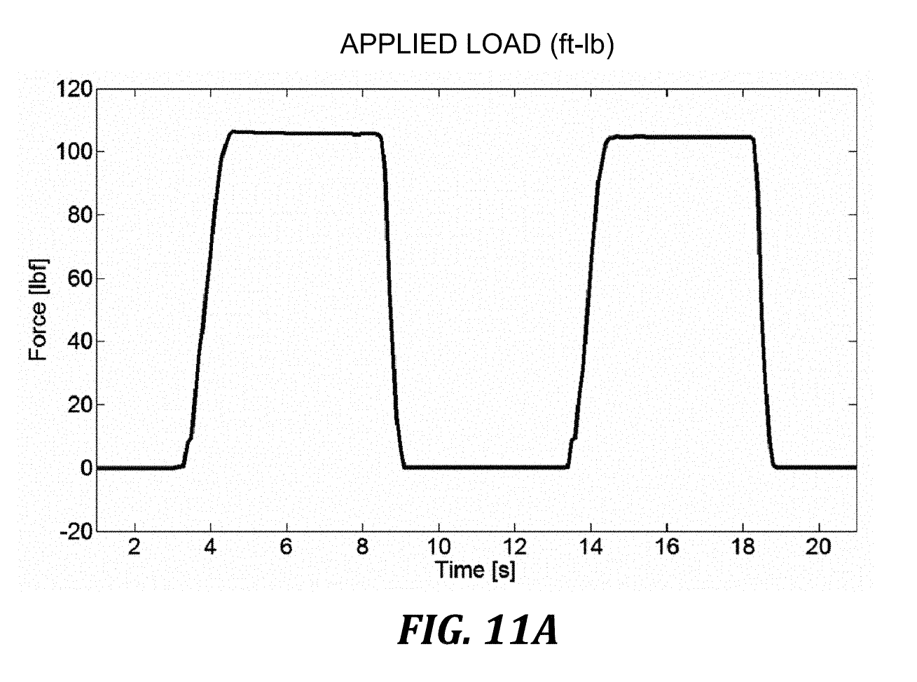

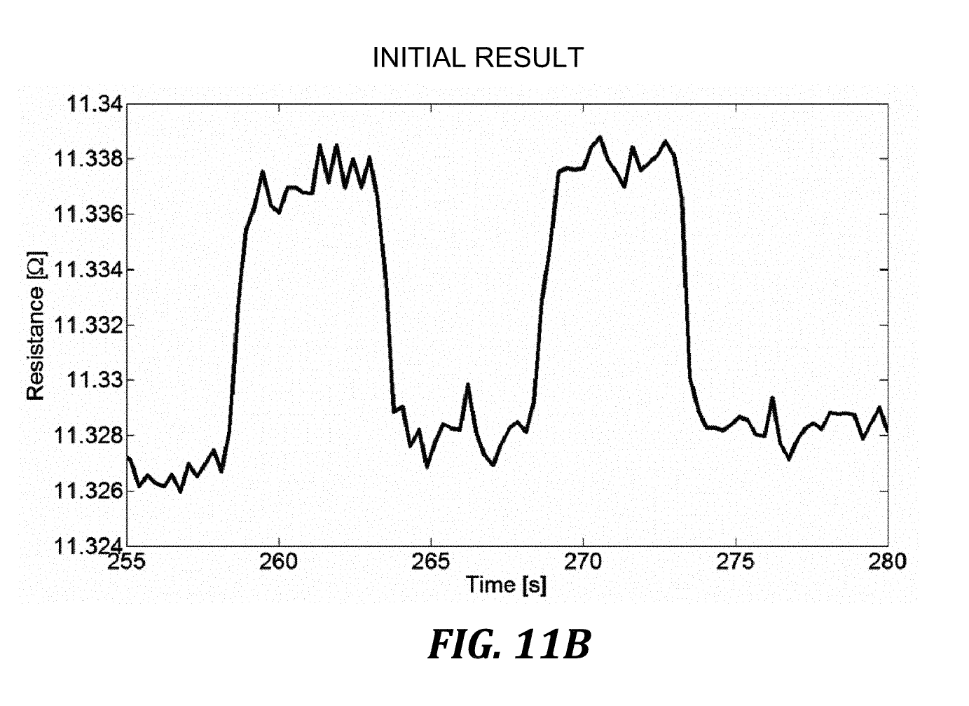

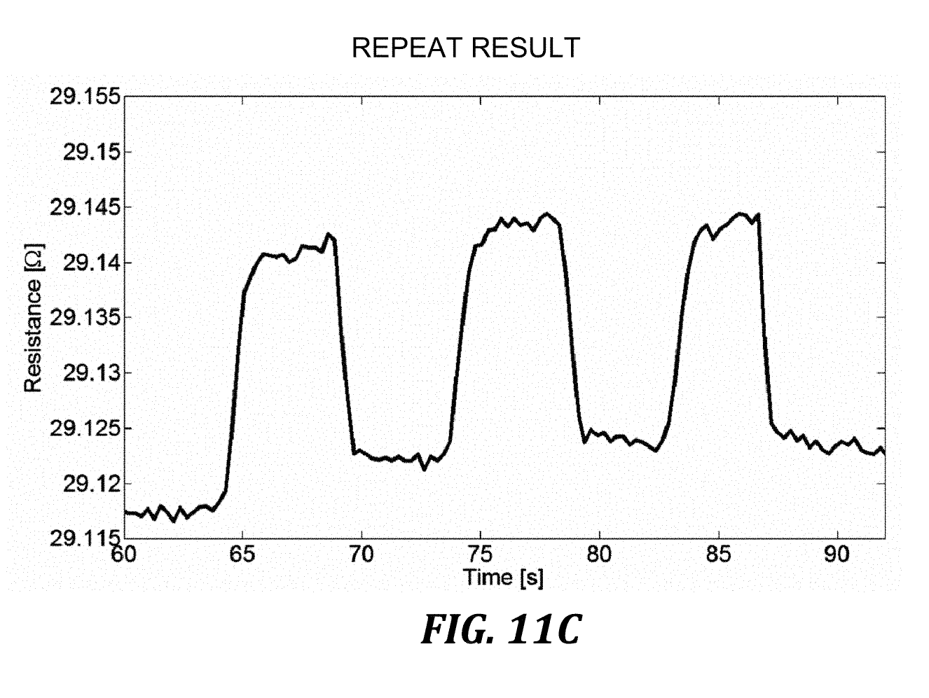

FIG. 11 shows strain gage testing of the device of FIG. 10A. These graphs were obtained by applying a known load several times over the specimen and it was recorded using a load cell. A load of 100 ft-lb is calculated to correspond to 300 microstrains. The response (electrical resistance) from the strain gages was recorded with a datalogger. The sampling rate used to record the responses was 5 Hz, which is a little slow and thus the data is somewhat noisy. The response curve followed the input signal very well and was repeatable to 0.03%. The gage factor was 2.4 compared to an industry standard of 2.

### Example 15

### Representative Example—Ag—YSZ:Ni-Graphite Thermocouple is Deposited on a Polyimide Film Substrate

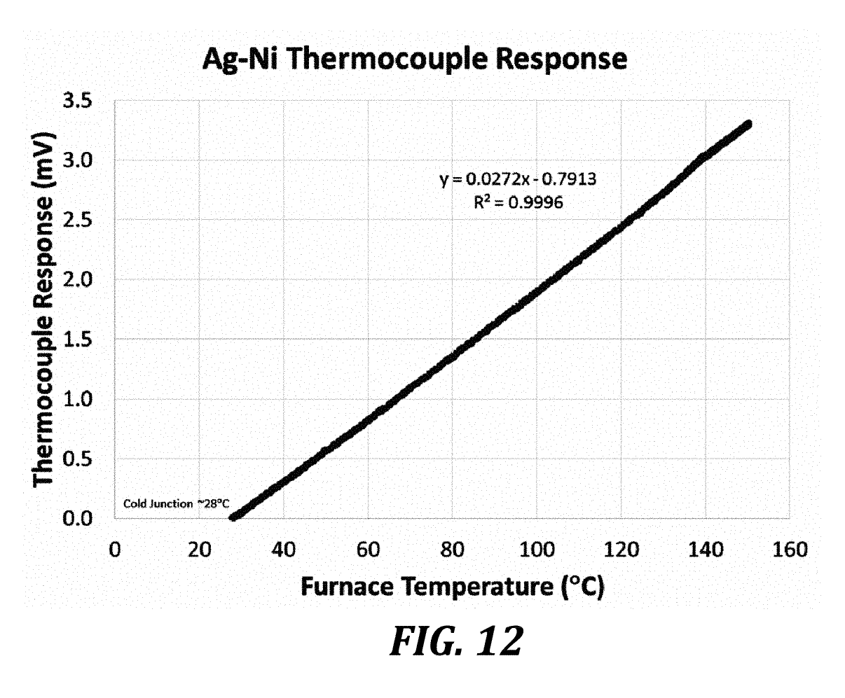

A polyimide Kapton film is cleaned with an isopropanol wipe and two minutes in an oxygen plasma. The silver-YSZ ink of Example 10 is printed in the pattern of a thermocouple arm and thermally cured to 300° C. for one hour in air. The nickel-graphite ink of Example 12 is then printed on top in the second thermocouple arm and cured photonically in a Novacentrix Pulse Forge photonic curing system. The article was placed in a furnace with Seebeck coefficient matched lead wires (copper for the silver and nickel for the nickel) running from the sample to a meter. The cold junction was effectively at room temperature 28° C. with no compensation. The Seebeck coefficient thermocouple voltage between these arms is shown to be linear versus temperature in FIG. 12.

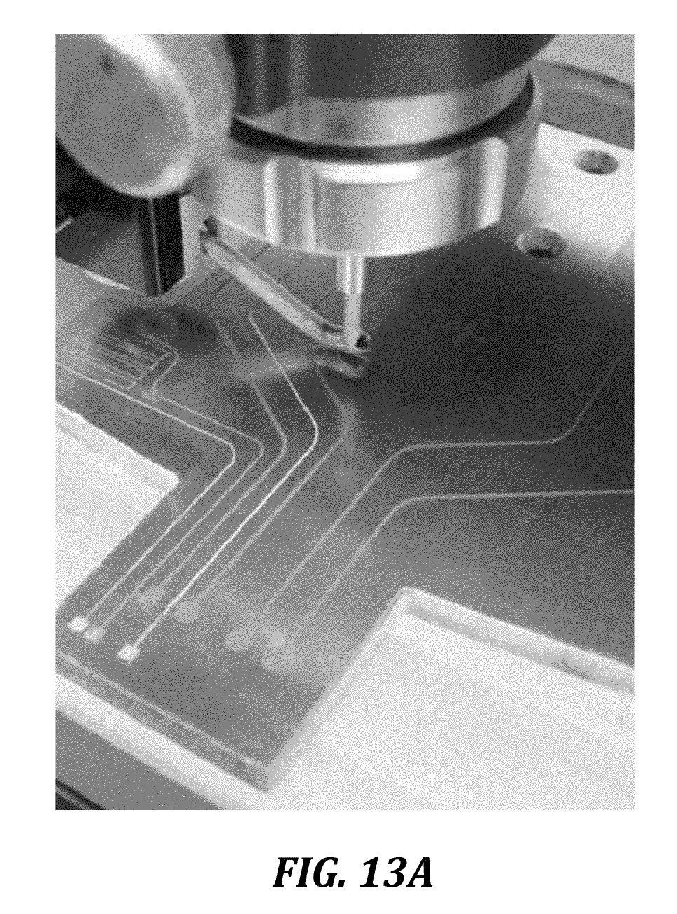

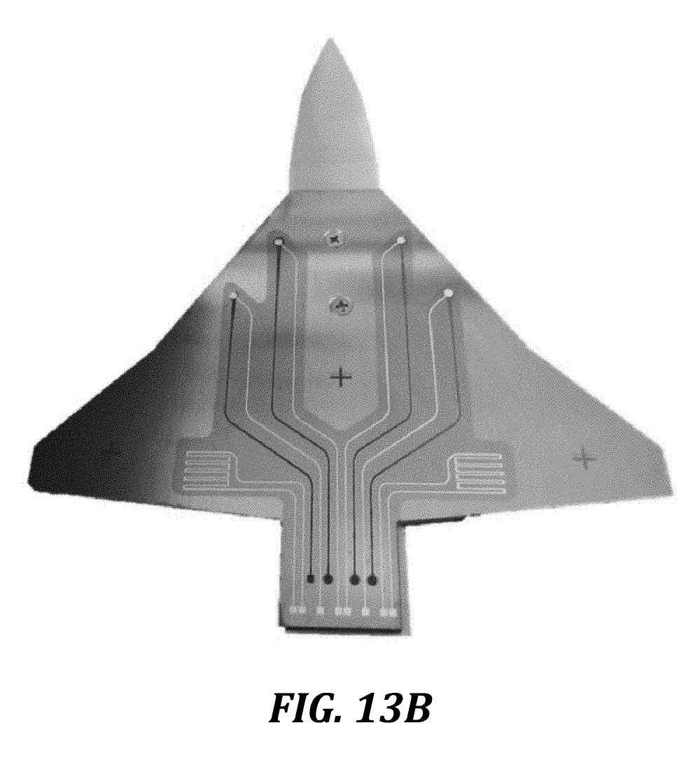

A demonstration aircraft model with similarly printed silver and nickel traces is shown in FIG. 13 with silver strain gages and silver-nickel thermocouples. In this case the silver traces were printed using the AJ system as shown in FIG. 13A.

### Example 16

### Representative Example—YSZ Ink

Formulate a YSZ ink as follows. In a solvent mixture of 85% toluene and 15% alpha-terpineol by volume, stir in 55% by weight YSZ nanopowder 5-10 nm in size and 0.5% by weight DISPERBYK 111 polar dispersant (BYK Additives and Instruments, Geretsried, Germany). Homogenize in an ultrasonic bath for 30 minutes, mix for 30 minutes in a planetary mixer, stir overnight in a magnetic stirrer and then further homogenize in a planetary mixer for another 30 minutes and in an ultrasonic bath for 30 minutes. Stir the ink continuously in a magnetic stirrer until it is used to prevent precipitation, separation, or agglomeration and then homogenize ultrasonically for 30 minutes immediately before use.

The YSZ ink can be used as an insulating base as in FIG. 10B and also top cover for the sensors as YSZ is an extremely stable refractory material. In the case of YSZ film deposition, the ink also requires a binder such as 0.5% by weight poly(vinyl) butyral (PVB) or other non-organic binder such as kaolin.

Aerosol jet printing the YSZ ink must be done with the pneumatic atomizer because the high loading (˜55%) results in high viscosity. No additional solvent addition is made. The pneumatic atomizer operates by shearing action of the fluid with very high gas volumes. The excess gas is stripped off by a “virtual impactor” such that the atomizer gas flow is 950 ccm, the virtual impactor draws off 900 ccm of that leaving only 50 ccm to proceed to the nozzle. The sheath gas is set at 40 ccm. The ink reservoir is not heated, but the tube heater is set at 30° C. The platen is not heated. A 300 μm nozzle is used and the platen moves at 5-8 mm/second producing an approximate printed trace width of 120 μm. The pattern is a simple rectangular fill 30×18 mm and the sample is dried/cured at 200° C. for 75 minutes. For full sintering, YSZ inks require sintering at very high temperatures >1000° C.

The strain gage of FIG. 10B is printed in the same manner as Example 10, but the pattern is instead comprised of 10 turns of 50 μm wide, 100 μm spacing serpentine.

Any approximate terms, such as “about,” “approximately,” and “substantially,” indicate that the subject can be modified by plus or minus 5% and fall within the described embodiment.

While illustrative embodiments have been illustrated and described, it will be appreciated that various changes can be made therein without departing from the spirit and scope of the invention.

The embodiments of the in invention in which an exclusive property or privilege is claimed are defined as follows:

1. A refractory metal ink comprising a refractory metal species and a solvent, wherein the refractory metal ink is configured to form an alloy that is hardened against grain boundary motion when the solvent is removed.

2. The refractory metal ink of claim 1, wherein the refractory metal species is selected from the group consisting of:
nanoparticles comprising two or more refractory metals selected from the group consisting of platinum, gold, palladium, silver, rhodium, iridium, nickel, tungsten, chromium, rhenium, and molybdenum;
two or more types of refractory metal nanoparticles selected from the group consisting of platinum nanoparticles, gold nanoparticles, palladium nanoparticles, silver nanoparticles, rhodium nanoparticles, iridium nanoparticles, nickel nanoparticles, tungsten nanoparticles, chromium nanoparticles, rhenium nanoparticles, and molybdenum nanoparticles;
two or more refractory metal organic species comprising a metal center and an organic ligand coordinated with the metal center, wherein the metal center is selected from the group consisting of a platinum atom or group of platinum atoms, a gold atom or group of gold atoms, a palladium atom or group of palladium atoms, a silver atom or group of silver atoms, a rhodium atom or group of rhodium atoms, an iridium atom or group of iridium atoms, a nickel atom or group of nickel atoms, a tungsten atom or group of tungsten atoms, a chromium atom or group of chromium atoms, a rhenium atom or group of rhenium atoms, and a molybdenum atom or group of molybdenum atoms; and
combinations thereof.

3. The refractory metal ink of claim 1, wherein the refractory metal species comprises a microparticle having a diameter between about 100 nm and about 50 μm, wherein the microparticle comprises two or more refractory metals and excludes the combination of platinum and rhodium.

4. The refractory metal ink of claim 1, wherein the refractory metal species comprise a majority metal constituent and a minority metal constituent different from the majority metal constituent, wherein the majority metal constituent comprises a metal selected from the group consisting of platinum, gold, palladium, silver and nickel with a concentration greater than or equal to 60% by weight of the total metal species and the minority metal constituent comprises a metal selected from the group consisting of rhodium, gold, palladium, and iridium with a concentration less than or equal to 40% by weight of the total metal species.

5. The refractory metal ink of claim 1, wherein the refractory metal species comprises a majority metal constituent and a minority metal constituent different from the majority metal constituent, wherein the majority metal constituent comprises a metal selected from the group consisting of platinum, gold, palladium, silver and nickel with a concentration greater than or equal to 85% by weight of the total metal species and the minority metal constituent comprises metals selected from the group consisting of nickel, tungsten, chromium, rhenium, and molybdenum with a concentration less than or equal to 15% by weight of the total metal species.

6. The refractory metal ink of claim 1, further comprising solid non-metal particles, wherein the refractory metal ink is configured to form a metal article hardened against high-temperature grain boundary motion by incorporation of the solid non-metal particles when the solvent is removed.

7. The refractory metal ink of claim 6, wherein the refractory metal species are selected from the group consisting of:
one or more types of refractory metal nanoparticles selected from the group consisting of platinum nanoparticles, gold nanoparticles, palladium nanoparticles, silver nanoparticles, rhodium nanoparticles, iridium nanoparticles, nickel nanoparticles, tungsten nanoparticles, chromium nanoparticles, rhenium nanoparticles, and molybdenum nanoparticles;
nanoparticles comprising an alloy of two or more refractory metals selected from the group consisting of platinum, gold, palladium, silver, rhodium, iridium, nickel, tungsten, chromium, rhenium, and molybdenum;
one or more refractory metal organic species comprising a metal center and an organic ligand, wherein the metal center is selected from the group consisting of a platinum atom or group of platinum atoms, a gold atom or group of gold atoms, a palladium atom or group of palladium atoms, a silver atom or group of silver atoms, a rhodium atom or group of rhodium atoms, an iridium atom or group of iridium atoms, a nickel atom or group of nickel atoms, a tungsten atom or group of tungsten atoms, a chromium atom or group of chromium atoms, a rhenium atom or group of rhenium atoms, and a molybdenum atom or group of molybdenum atoms; and
combinations thereof.

8. The refractory metal ink of claim 6, wherein the refractory metal species comprises a microparticle having a diameter between about 100 nm and about 50 μm.

9. The refractory metal ink of claim 6, wherein the solid non-metal particles comprise materials selected from the group consisting of aluminum oxide, zirconium oxide, yttrium oxide, cerium oxide, silicon oxide, yttria stabilized zirconia, silicon carbide, graphite, carbon nano-tubes, diamondoid, and combinations thereof.

10. The refractory metal ink of claim 1, further comprising an additive selected from the group consisting of a capping agent, a dispersant, a surfactant, and a binder.

11. The refractory metal ink of claim 1, wherein the solvent is selected from the group consisting of ethanol, isopropyl alcohol, 1-methoxy 2-propanol, ethylene glycol, alpha-terpineol, toluene, 2-butanol, n-methyl-2-pyrrolidone (NMP), water, and combinations thereof.

12. The refractory metal ink of claim 1, wherein the refractory metal ink has a characteristic selected from the group consisting of:
the solvent is a mixture of solvents with high and low vapor pressures;
the ink has a solids loading fraction between 15% and 25% by volume;
the ink has a viscosity less than 10 centipoise;
the ink has a surface tension between 30 and 55 milli-Newtons per meter; and
combinations thereof.

13. The refractory metal ink of claim 12, wherein the high vapor pressure solvent has a vapor pressure greater than about 0.5 kPa at 25° C. and the low vapor pressure solvent has a vapor pressure less than about 0.1 kPa at 25° C.

14. An article at least partially deposited from a refractory metal ink, wherein the article comprises one of the group consisting of a metal alloy and an inclusion of a solid non-metal particle and wherein the article is hardened against high-temperature grain boundary motion.

15. The article of claim 14, wherein the article is formed by depositing the refractory metal ink on a substrate using additive manufacturing methods selected from the group consisting of aerosol jet printing, inkjet printing, micro-syringe dispense printing, screen printing, roll-to-roll printing, and combinations thereof.

16. The article of claim 14, wherein the article is selected from a strain gage and a thermocouple.

17. The article of claim 14, wherein the article is an electrical connector and the electrical connector is selected from the group consisting of an interconnect, an antenna, a communication line, a power connector, an interdigitated electrode, a capacitor, an inductor, a resistance temperature detector and an environmental sensor.

18. The article of claim 14, wherein the article comprises an insulating ceramic applied under the conductor, applied over the conductor, or both.

19. The article of claim 18, wherein the insulating ceramic comprises a material selected from the group consisting of yttrium stabilized zirconia, a high-temperature ceramic cement, an oxide material formed by metalorganic decomposition, and combinations thereof.

20. A method of making a patterned article comprising:
depositing a refractory metal ink of claim 1 on a substrate in a pattern; and
curing the deposited refractory metal ink to provide a patterned article.
